(19) United States
(12) Patent Application Publication
(10) Pub. No.: US 2017/0161056 A1
(43) Pub. Date: Jun. 8, 2017

(54) Methods for Managing the Writing of Datasets by Computer-Implemented Processes

(71) Applicant: Happy Cloud Inc., New York City, NY (US)

(72) Inventors: Gavriel Raanan, Beit Shemesh (IL); Lawrence Reisler, Beit Shemesh (IL); Jacob Guedalia, New York City, NY (US); Isaac David Guedalia, Bet Shemesh (IL)

(21) Appl. No.: 15/435,742

(22) Filed: Feb. 17, 2017

Related U.S. Application Data
(63) Continuation-in-part of application No. 15/420,729, filed on Jan. 31, 2017.
Application No. 15/420,729 is a continuation of application No. 14/859,408, filed on Sep. 21, 2015.
Application No. 14/859,408 is a continuation of application No. 14/296,642, filed on Jun. 5, 2014, now abandoned.
Application No. 14/296,642 is a continuation of application No. 13/412,765, filed on Mar. 6, 2012, now Pat. No. 8,782,053.
(60) Provisional application No. 61/449,675, filed on Mar. 6, 2011.

(51) Int. Cl. G06F 9/445; G06F 17/30; G06F 3/06

(52) U.S. Cl. CPC G06F 8/67; G06F 3/0604; G06F 3/0637; G06F 3/0652; G06F 3/067; G06F 17/30362; G06F 17/30171; G06F 17/30117

(57) ABSTRACT

A first computer-implemented process writes a first dataset to data storage locations on at least one data storage device. A request by the first or a second computer-implemented process to write a second dataset to one of the data storage locations where the first computer-implemented process has written some or all of the first dataset is identified. A list of protected or unprotected data portions is checked before the first or second computer-implemented process writes the second dataset. The first or second computer-implemented process writes a portion of the second dataset to a selected data storage location in the data storage device only if the resident data portion stored in the selected data storage location is (a) included in the list of unprotected data portions or (b) not included in the list of protected data portions.

### CROSS-REFERENCE TO RELATED APPLICATIONS

This application is a continuation-in-part of U.S. patent application Ser. No. 15/420,729, filed on Jan. 31, 2017, which is a continuation of U.S. patent application Ser. No. 14/859,408, filed on Sep. 21, 2015, which is a continuation of U.S. patent application Ser. No. 14/296,642, filed on Jun. 5, 2014, which is a continuation of U.S. patent application Ser. No. 13/412,765, filed on Mar. 6, 2012, which claims priority to U.S. Provisional Patent Application No. 61/449,675, filed on Mar. 6, 2011, which are incorporated herein by reference in their entirety.

### FIELD OF THE INVENTION

This application relates to data streaming and managing the writing of datasets.

### BACKGROUND OF THE INVENTION

Current data streaming methods enable a computer user to view of listen to a portion of video or music data file while downloading subsequent portions of file. However, existing streaming methods cannot be used to download, or otherwise install an interactive software application, such as a computer game, where the entire application must be downloaded to the user's computer before the game can be played.

### SUMMARY OF THE INVENTION

The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Other objects, advantages and novel features of the disclosure will be set forth in the following detailed description of the disclosure when considered in conjunction with the drawings.

In an aspect, the invention is directed to a computer-implemented method for managing the writing of datasets, the method comprising: initiating a first computer-implemented process to write a plurality of portions of a first dataset to a corresponding plurality of data storage locations on at least one data storage device; maintaining a list of unprotected data portions that may be the subject of a write request by the first or a second computer-implemented process for new data; identifying a request made by the first or second computer-implemented process to write a second dataset to one of the data storage locations that the first computer-implemented process has written some or all of the portions of the first dataset to; checking the list of unprotected data portions before writing any of the portions of the second dataset to a selected data storage location among any of the data storage locations to determine whether or not the selected data storage location is available for writing to based on whether a resident data portion stored in the selected data storage location is included in the list of unprotected data portions; and writing to the selected data storage location only if the resident data portion is included in the list of unprotected data portions.

In one or more embodiments, the portions of the first dataset include first supplemental data for a computer software application running on a client device. In one or more embodiments, the second dataset corresponds to at least one update to the first supplemental data for the computer software application. In one or more embodiments, the computer software application initiates the first computer-implemented process. In one or more embodiments, the second dataset includes second supplemental data for the computer software application. In one or more embodiments, the second supplemental data include a pointer to a portion of the first supplemental data written to a protected data storage location.

In one or more embodiments, the method further comprises determining that a portion of the first supplemental data is a common data portion to the second supplemental data. In one or more embodiments, the method further comprises removing the common data portion from the list of unprotected data portions. In one or more embodiments, the method further comprises deleting data portions that are included in the list of unprotected data portions. In one or more embodiments, the the deleting occurs when the data portions are not referenced or accessed by a computer software application, the computer software application and the first computer-implemented process running on a client device.

In one or more embodiments, the method further comprises receiving, from the computer software application, a release notification that indicates that a portion of the first supplemental data is no longer needed by the computer software application. In one or more embodiments, the deleting occurs when an available storage volume of the data storage device falls below a predetermined minimum available storage volume. In one or more embodiments, the deleting occurs when a total volume of data stored on the data storage device by the first computer-implemented process exceeds a predetermined maximum storage volume allocated to the first computer-implemented process. In one or more embodiments, the method further comprises determining a deletion priority of the data portions that are included in the list of unprotected data portions; and determining an order of deletion of the data portions that are included in the list of unprotected data portions based, at least in part, on the deletion priority.

Another aspect of the invention is directed to a computer-implemented method for managing the writing of datasets. The method comprises initiating a first computer-implemented process to write a plurality of portions of a first dataset to a corresponding plurality of data storage locations on at least one data storage device; maintaining a list of protected data storage portions that may be the subject of a write request by the first or second computer-implemented process for new data; identifying a request made by the first or a second computer-implemented process to write a second dataset to one of the data storage locations that the first computer-implemented process has written some or all of the portions of the first dataset to; checking the list of protected data portions before writing any of the portions of the second dataset to a selected data storage location among any of the data storage locations to determine whether or not the selected location is available for writing to based on whether or not a resident data portion stored in the selected data storage location is included in the list of protected data portions; and writing to the selected data storage location only if the resident data portion is not included in the list of protected data portions.

In one or more embodiments, the method further comprises deleting data portions that are not included in the list of protected data portions. In one or more embodiments, the deleting occurs when the data portions are not referenced or accessed by a computer software application, the computer software application and the first computer-implemented process running on a client device. In one or more embodiments, the method further comprises receiving, from the computer software application, a release notification that indicates that a portion of the first supplemental data is no longer needed by the computer software application. In one or more embodiments, the deleting occurs when (a) an available storage volume of the data storage device falls below a predetermined minimum available storage volume or (b) a total volume of data stored on the data storage device by the first computer-implemented process exceeds a predetermined maximum storage volume allocated to the first computer-implemented process. In one or more embodiments, the method further comprises determining a deletion priority of the data portions that are not included in the list of protected data portions; and determining an order of deletion of the data portions that are not included in the list of protected data portions based, at least in part, on the deletion priority.

Other features and advantages of the invention will be apparent from the following detailed description, from the drawings, and from the claims.

### BRIEF DESCRIPTION OF THE DRAWINGS

The invention will be understood and appreciated more fully from the following detailed description taken in conjunction with the appended drawings in which:

FIG. 1A is a simplified conceptual illustration of a system for managing the execution of a software application, constructed and operative in accordance with an embodiment of the invention;

FIG. 1B is a simplified conceptual illustration of an implementation of manager 100 of FIG. 1A, constructed and operative in accordance with an embodiment of the invention;

FIGS. 2A and 2B, taken together, is a simplified flowchart illustration of an exemplary method of operation of the system of FIGS. 1A and 1B, operative in accordance with an embodiment of the invention;

FIGS. 3A and 3B, taken together, provide a simplified conceptual illustration of a system for preparing a software application for execution by a computer, constructed and operative in accordance with an embodiment of the invention; and

FIG. 4 is a simplified flowchart illustration of an exemplary method of operation of the system of FIGS. 3A and 3B, operative in accordance with an embodiment of the invention.

FIG. 5 is another simplified conceptual illustration of an implementation of manager 100 of FIG. 1A, constructed and operative in accordance with an embodiment of the invention;

FIG. 6A is a simplified flowchart illustration of an exemplary method of operation of the system of FIG. 5, operative in accordance with an embodiment of the invention;

FIG. 6B is a simplified flowchart illustration of an exemplary method of operation of the system of FIG. 5, operative in accordance with an embodiment of the invention;

FIGS. 7A-7B shows exemplary results of an implementation of the method of FIG. 6A-6B;

FIG. 8 is a simplified flowchart illustration of an exemplary method of operation of the system of FIG. 5 relating to defining blocks, operative in accordance with an embodiment of the invention;

FIGS. 9A-9B show exemplary results of an implementation of the method of FIG. 8;

FIG. 10A is a simplified flowchart illustration of an exemplary method of operation of the system of FIG. 5 relating to evaluating a candidate index file, operative in accordance with an embodiment of the invention;

FIG. 10B is a simplified flowchart illustration of an exemplary method of operation of the system of FIG. 5 relating to evaluating a candidate index file, operative in accordance with an embodiment of the invention;

FIG. 11 is a simplified flowchart illustration of an exemplary method for determining an order of data retrieval based on a data retrieval plan, according to one or more embodiments of the invention;

FIG. 12 is a simplified flowchart illustration of an exemplary method for retrieving a computer software application on a client device, according to one or more embodiments of the invention;

FIG. 13 which is a simplified flowchart illustration of an exemplary method for installing a computer software application on a client device, according to one or more embodiments of the invention;

FIG. 14 is a simplified conceptual illustration of a system for managing the writing of a dataset to a data storage device, according to one or more embodiments;

FIG. 15 is a simplified conceptual illustration of a system for managing the writing of a dataset to a data storage device, according to one or more embodiments;

FIG. 16 which is a simplified flowchart illustration of an exemplary method for managing the writing of a dataset, according to one or more embodiments of the invention; and

FIG. 17 which is a simplified flowchart illustration of an exemplary method for managing the writing of a dataset, according to one or more embodiments of the invention.

### DETAILED DESCRIPTION OF THE INVENTION

The invention is now described within the context of one or more preferred embodiments, although the description is intended to be illustrative of the invention as a whole, and is not to be construed as limiting the invention to the embodiments shown. It is appreciated that various modifications may occur to those skilled in the art that, while not specifically shown herein, are nevertheless within the true spirit and scope of the invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical data storage device, a magnetic data storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

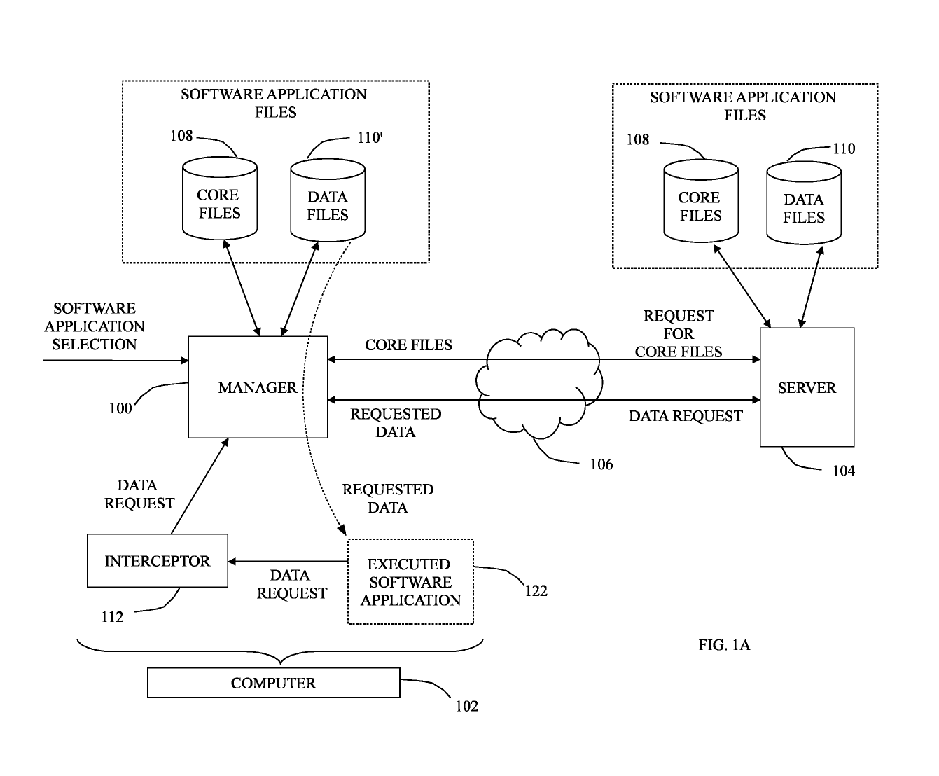

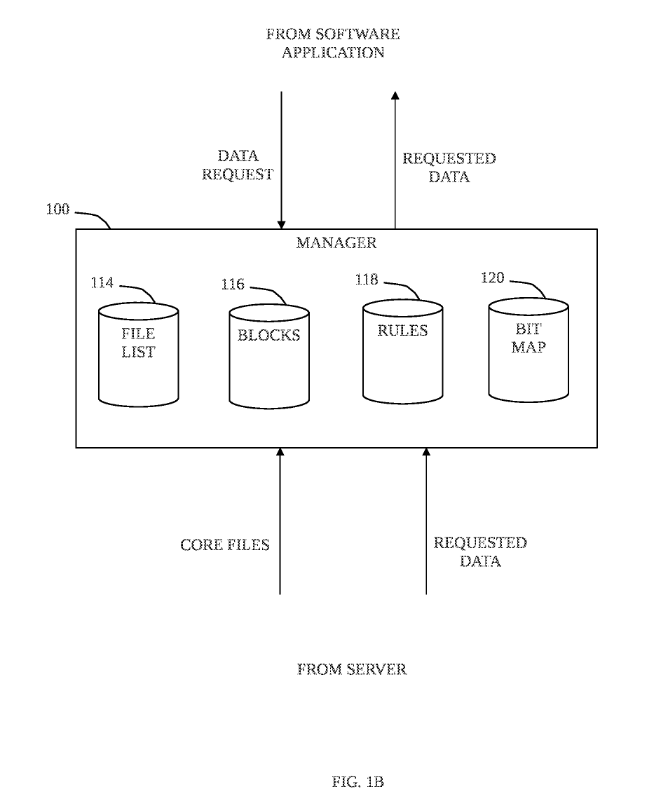

Reference is now made to FIG. 1A, which is a simplified conceptual illustration of a system for managing the execution of a software application, constructed and operative in accordance with an embodiment of the invention. In the system of FIG. 1A, a computer 102 is configured with a manager 100 that enables a user of computer 102 to indicate to manager 100, using any known technique, a software application, such as a computer-based game, for execution by computer 102. Manager 100 preferably determines if the software application is ready to be executed on computer 102, such as where manager 100 previously installed the software application for execution by computer 102 as described in greater detail hereinbelow, and executes the application if it is ready to be executed. If the software application is not ready to be executed by computer 102, manager 100 preferably retrieves a predefined portion of the software application, such as from local data storage media, and/or by downloading the predefined portion of the software application from a server 104, such as via a communications network 106, such as the Internet. As is described in greater detail hereinbelow, the predefined portion of the software application is preferably in the form of one or more computer files in a set of core files 108, where the software application is made up of core files 108 and a set of data files 110 that is stored on a data storage device, such as on server 104, or alternatively on a Digital Versatile Disk (DVD). Manager 100 then installs the software application for execution by computer 102, preferably by creating on a local data storage device that is accessible to computer 102 a predefined directory structure that is required by the software application and placing the files of core files 108 into predefined locations within the directory structure. Manager 100 also preferably creates a set of placeholder files 110′ within the directory structure, such as by using SparseFiles™ API for Microsoft Windows™, where each placeholder file in set 110′ corresponds to a file in data files 110. The directory structure, file locations within the directory structure, and the names and sizes of the files in data files 110 are preferably known in advance to manager 100 or are otherwise acquired by manager 100 using conventional techniques, such as from local data storage media and/or from server 104. Once installed, manager 100 preferably initiates the execution of the software application by computer 102, such as by executing one of core files 108 that is predefined to cause the execution of the software application, thereby creating an instance of an executed software application 122.

Computer 102 also preferably includes an interceptor 112 that is configured to intercept requests made by executed software application 122 to retrieve data from placeholder files 110′, preferably where interceptor 112 prevents the operating system of computer 102 from processing the request, such as by withholding the request from the operating system. Interceptor 112 then forwards the request to manager 100. When manager 100 receives a request for data from interceptor 112, manager 100 determines whether the requested data are present within placeholder files 110′. If the requested data are present within placeholder files 110′, manager 100 allows executed software application 122 to retrieve the requested data from placeholder files 110′, preferably by allowing the operating system of computer 102 to process the request, such as by forwarding the request to the operating system or instructing interceptor 112 to forward the request to the operating system. If the requested data are not present within placeholder files 110′, manager 100 retrieves the requested data from their location(s) within data files 110, and places the retrieved data into their corresponding location(s) within placeholder files 110′. Manager 100 then allows executed software application 122 to retrieve the requested data from placeholder files 110′, such as is described above. Manager 100 may also retrieve other data from data files 110 in advance of requests by executed software application 122 to retrieve such data, as is described hereinbelow in greater detail.

Reference is now made to FIG. 1B, which is a simplified conceptual illustration of an implementation of manager 100 of FIG. 1A, constructed and operative in accordance with an embodiment of the invention. In the system of FIG. 1B, manager 100 preferably includes a file list 114 of the computer files that make up a software application that is managed by manager 100 as described herein, where file list 114 preferably indicates whether a file is one of core files 108 or one of data files 110. Manager 100 also preferably includes a set of block definitions 116 having multiple named records referred to as “blocks,” where each block includes one or more references to data within data files 110. Manager 100 also preferably includes a set of rules 118, where each rule is associated with a block and determines if and how data that are referred to in the block, or in one or more other blocks, are to be downloaded from data files 110, whereupon the data that are retrieved from data files 110 are placed by manager 100 in placeholder files 110′. Manager 100 also preferably maintains a record of the data that have been retrieved and placed in placeholder files 110′, such as by maintaining a bitmap 120 indicating locations within placeholder files 110′ to which retrieved data were written. Any of the file, block, and rule data described hereinabove are preferably known in advance to manager 100 or are otherwise acquired by manager 100 using conventional techniques, such as from local data storage media and/or from server 104.

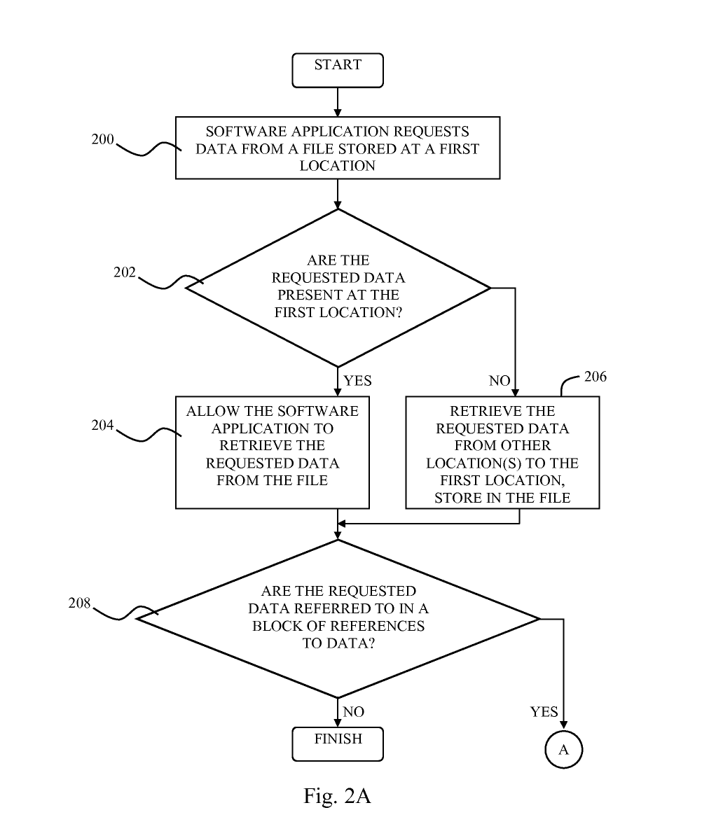

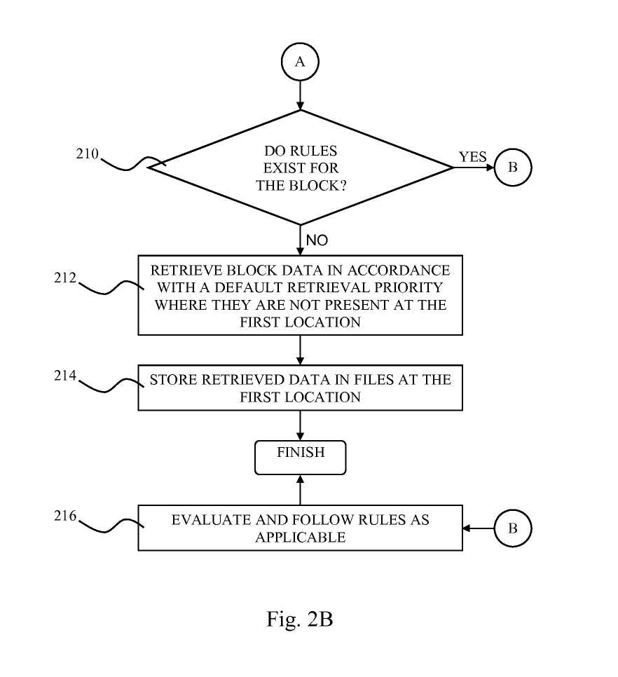

Reference is now made to FIGS. 2A and 2B, which, taken together, is a simplified flowchart illustration of an exemplary method of operation of the system of FIGS. 1A and 1 B, operative in accordance with an embodiment of the invention. In the method of FIGS. 2A and 2B, a request made by a software application during its execution by a computer is received or is otherwise detected, where the request is to retrieve data from a file stored at a first location (step 200), preferably on a data storage device that is locally accessible to the computer. The name of the file, and typically the location of the requested data within the file, are specified as part of the request. If the requested data are present in the file (step 202), the software application is allowed to retrieve the requested data from the file, or the data are otherwise provided to the software application (step 204). If the requested data are not present in the file, the requested data are retrieved from one or more locations other than the first location, such as from a remote server where a copy of the requested data is stored and that is accessible via a communications network, and places the retrieved data into their corresponding location(s) within the file stored at the first location (step 206), whereupon the software application is allowed to retrieve the requested data from the file, or the data are otherwise provided to the software application (step 204).

If the requested data are referred to in a predefined block that includes one or more references to data that are associated with the software application (step 208), and if the block has no predefined rules associated with it (step 210), then the data referred to in the block are preferably retrieved in accordance with a default retrieval priority where they are not present at the first location (step 212), such as by retrieving the data from the remote server. The retrieved data are then stored in predefined locations within corresponding files stored at the first location (step 214). If the block has one or more predefined rules associated with it, then the rules are evaluated and followed where applicable (step 216), such as where the rules indicate that data referred to in the block, and/or in one or more other blocks, are to be retrieved, and at what retrieval priority. A description of examples of such rules and their application now follows.

Where the data referred to in a block are to be retrieved as described hereinabove, the block may be logically placed in a priority queue together with an indicator of a retrieval priority, such as an integer between 1 and 9, where 1 indicates the highest level of retrieval priority. Data referred to in higher priority blocks in the priority queue are preferably retrieved before data referred to in lower priority blocks unless otherwise indicated by a rule. Data referred to in multiple blocks with equal priority are preferably retrieved in a round-robin fashion. Rules associated with a block may affect the priority queue as follows:
by adding any block including itself to the priority queue with an integer priority level;
by modifying the priority of a block already in the queue by a certain positive or negative offset;
by removing blocks from the priority queue based on full or partial block name matches (wildcards), or based on priority level (greater than, less than, or equal to a threshold value);
by setting a buffering threshold for a block, such that if a predefined amount of data referred to in the block has been retrieved and is and ready for use by the software application, the priority queue will temporarily stop retrieving data referred to in the block and allow data to be retrieved for other blocks in the priority queue, even if they have a lower retrieval priority, until a predefined amount of the retrieved data referred to in the block has been provided to the software application, whereupon data retrieval for the block may resume.
   Other types of rules associated with a block may include rules that:
cause a progress bar to appear during data retrieval, where the progress bar tracks the progress of the retrieval of data referred to by one or more specified blocks;
when a request is received from the software application for data that are referred to in a block, and the data are already present, withholds the data from the software application until the data referred to by one or more specified blocks have been completely retrieved.

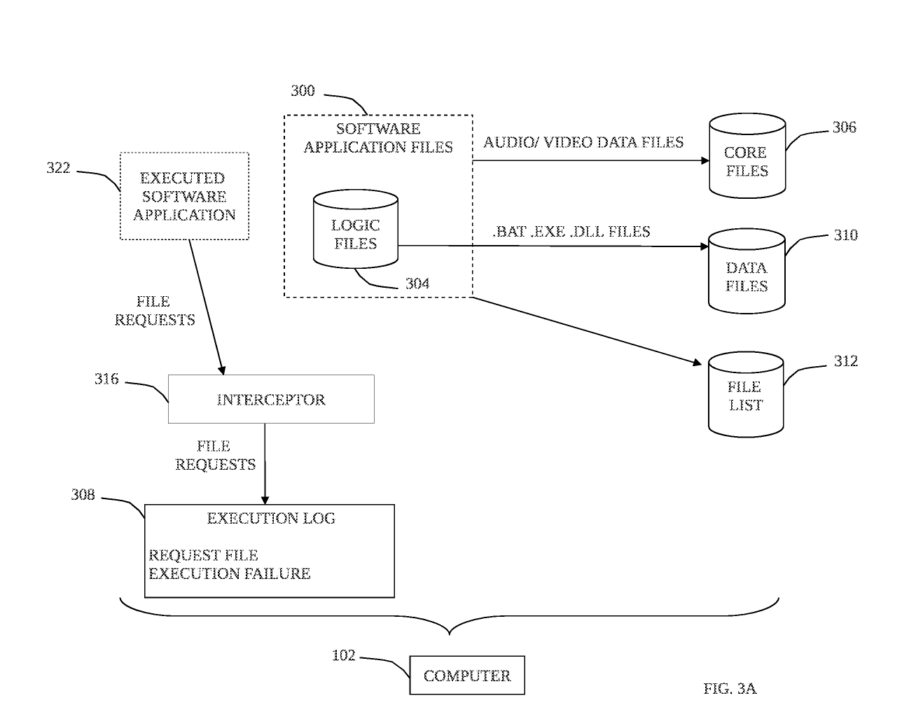

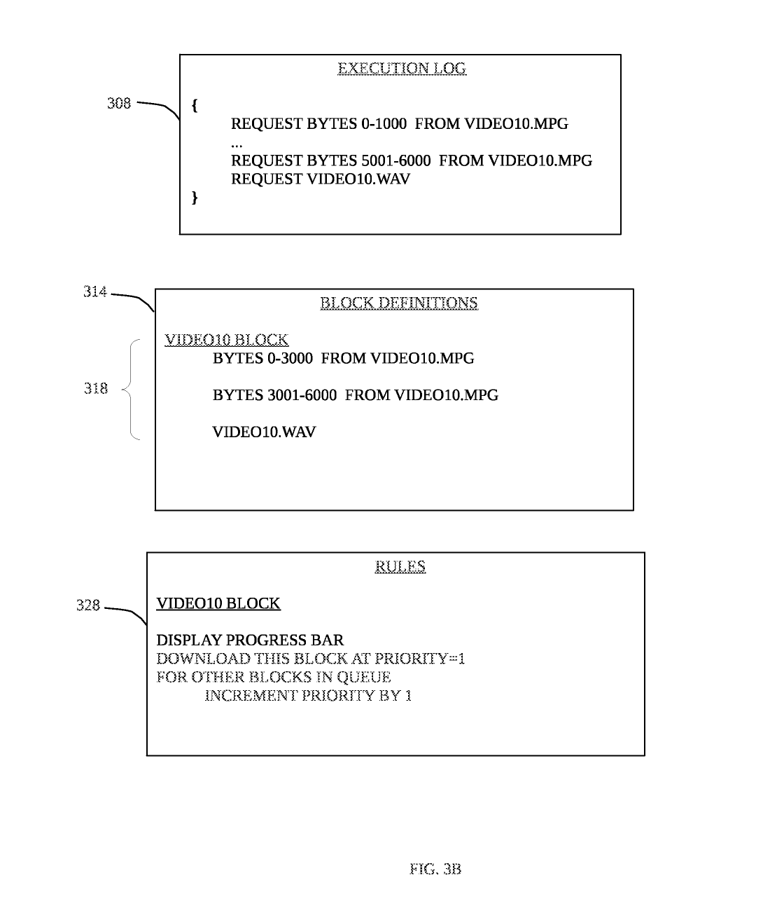

Reference is now made to FIGS. 3A and 3B, which, taken together, provide a simplified conceptual illustration of a system for preparing a software application for execution by a computer, constructed and operative in accordance with an embodiment of the invention. The system of FIGS. 3A and 3B may be used to prepare a software application for execution as described hereinabove. In FIG. 3A, a software application 300, such as a computer-based game, is preferably installed on a computer 302 using conventional methods. Application 300 preferably includes one or more files that provide processing logic for application 300 that are added to a set of core files 306, such as files with names that include suffixes such as ‘.exe,’ ‘.dll’, or ‘.bat’. Application 300 also preferably includes one or more data files 310, which may include files such as audio files, video files, and any other files not in core files 306 that are used by application 300 when it is executed. The execution of application 300 is preferably initiated at computer 302, such as by executing one of core files 306 that is predefined to cause the execution of the application 300, thereby creating an instance of an executed software application 322. An execution log 308 is created in accordance with conventional techniques to record requests made by executed software application 322 for data from any of the files in data files 310, such as by configuring an interceptor 316 to intercept the requests and record the requests in log 308. If the execution fails, such as due to a request by executed software application 322 for a file in application 300 that was not included in core files 306, the file is preferably added to core files 306. This process is preferably repeated until core files 306 includes files of application 300 that, when executed, do not cause execution to fail, such as when their execution reaches a steady state, such as waiting for user input or requesting and waiting for data from data files 310. Data files 310 will typically include any other files that are used by application 300 when it is executed and that are not included in core files 306. A file list 312 of the files included in core files 306 and in data files 310 is preferably maintained.

As shown in FIG. 3B, block definitions set 314 is defined that includes one or more blocks of references to the requested data in data files 310. The blocks are preferably defined in a manner that groups logically related data, such as data that are requested from one or more files in data files 310 at a given point during the execution of application 300, or data that are requested sequentially from multiple files in data files 310 during a given execution interval of application 300. A block may be defined by a human operator by marking portions of log 308. For example, the operator may place a ‘{’ in log file 308 before the first request for data from a video file named “video10.mpg”, and a ‘}’ after the last request for data from the video file. References to the requested data that appear between the ‘{’and ‘}’ markers in log 308 may then be used to define a block 318. Additional optimizing techniques may be applied when defining a block, such as by dividing block 318 into two smaller blocks, one that includes references to audio data portions of “video10.mpg”, and one that includes references to video data portions of “video10.mpg”. Since the video data portions of a multimedia file are typically much larger than the audio data portions, the block that includes references to video data portions of “video10.mpg” may be further divided into two or more blocks. A set of rules 328 is shown, in which rules may be associated with specific blocks and defined for controlling block-related behavior as described hereinabove.

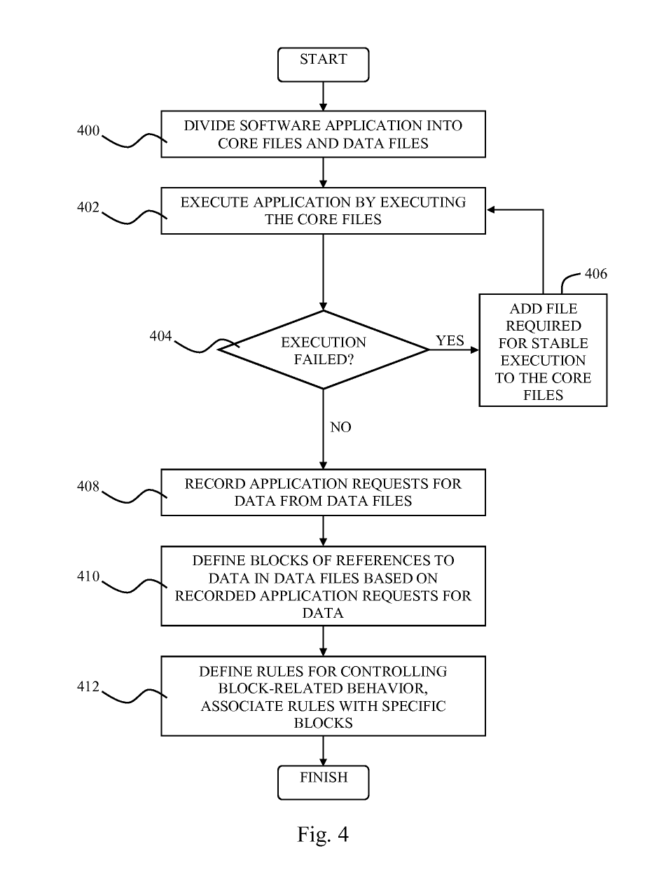

Reference is now made to FIG. 4, which is a simplified flowchart illustration of an exemplary method of operation of the system of FIGS. 3A and 3B, operative in accordance with an embodiment of the invention. In the method of FIG. 4, a software application is divided into core files and data files (step 400). The application is executed by executing the core files (step 402). If the execution fails (step 404) due to the absence of a file from the core files, the file is removed from the data files and added to core files (step 406). This process is preferably repeated until the core files includes those application files that, when executed, do not cause execution to fail, such as when their execution reaches a steady state, such as waiting for user input or requesting and waiting for data from the data files. Requests made by the application for data from any of the data files are recorded (step 408). One or more blocks are defined, where a block includes one or more references to data in the data files that are requested by the application (step 410). Rules are defined for controlling block-related behavior and are associated with specific blocks (step 412).

The system of FIGS. 3A and 3B and the method of FIG. 4 may be modified to optimize data retrieval efficiency from the server, such as by packaging together multiple data segments that may be referred to within the same block but may not necessarily reside in physically adjacent locations within the same data file. Data may also be stored in a compressed manner on the server. Multiple versions of audio and video files may be stored on the server, where each version of the same file is of a different quality, such that a smaller, lower-quality version of a file may be provided initially by the server, with a larger, higher-quality version being provided later.

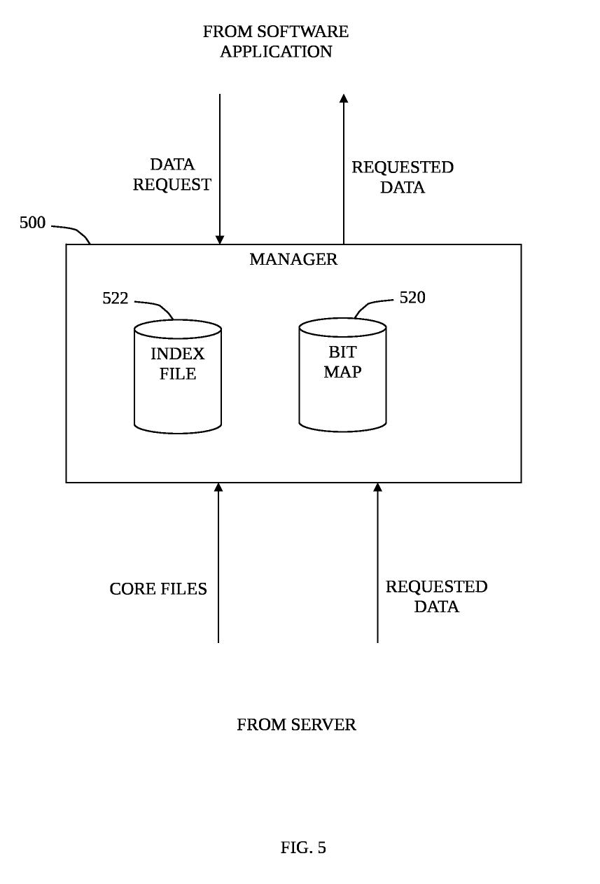

Reference is now made to FIG. 5 which is a simplified conceptual illustration of a system for preparing a software application for execution by a computer, constructed and operative in accordance with an embodiment of the invention. The system of FIG. 5 is substantially similar to that of FIG. 1B with the notable difference that file list 114, block definitions 116, and associated rules 118 are included in an index file 522. Upon obtaining a request for data, manager 500 determines if and how to download or otherwise retrieve the requested data in accordance with the block and rule definitions included in index file 522 and with a bitmap 520 that indicates what data have already been retrieved, in a manner similar to the method described in FIG. 1 B. Additionally, index file 522 preferably includes information required for installing the application, such as the directory for storing downloaded portions of the application, and a remote address for retrieving application files, and any other information that is relevant to installing and/or downloading the application.

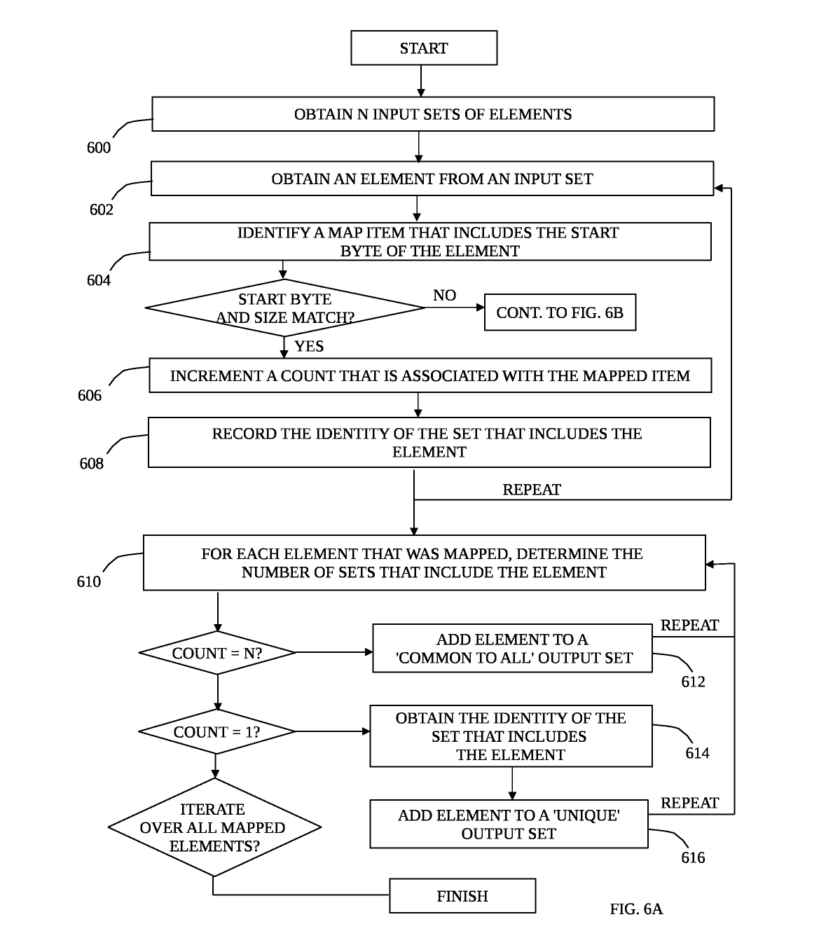

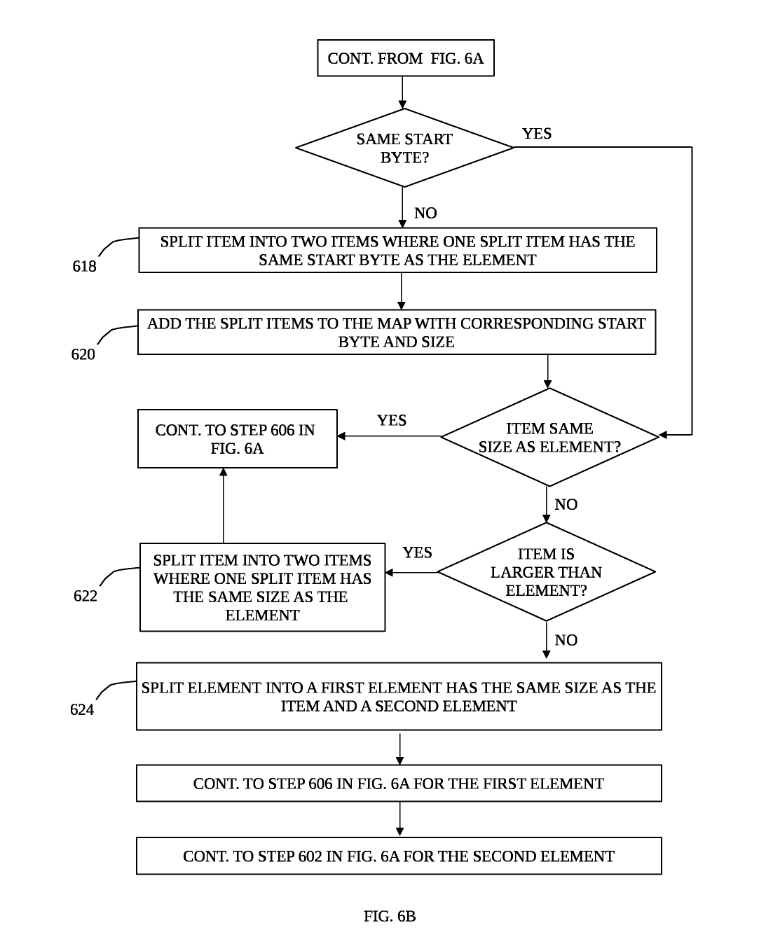

Reference is now made to FIG. 6A which is a simplified flowchart illustration of an exemplary method of operation of the system of FIG. 5, operative in accordance with an embodiment of the invention. The method of FIG. 6A relates to transforming multiple (N) input sets of elements to at most N+1 output sets, where each output sets includes only unique elements, and where one output set preferably includes elements that are common to all of the N input sets, and the remaining output sets each correspond to one of the N input sets and preferably only include elements that are unique to the corresponding input set. A map is preferably maintained for recording how many times an element is included in all the input sets. For example, a file map is maintained for each data file that is referenced by the blocks defined in the index file, where one or more items in the file map are preferably defined as a start byte, size, and a frequency count, and that uniquely span the file map. Requests for data, or elements, are preferably defined as a file name, start byte and size, and thus every element is associated with a file map according to the file name. The elements and maps are preferably defined in a manner that guarantees that every element maps onto one and only one item in the file map. The file map is preferably initialized with a single item defined with a start byte of zero, a size equal to the file size, and a count of zero.

Thus, in the method of FIG. 6A multiple (N) sets, or blocks, that preferably include one or more elements, such as one or more requests for data that include a name of a data file where the requested data are stored, a start address in the file for the requested data, and a size of the data request, are obtained (Step 600). An element of a set is preferably obtained (Step 602) and the element is preferably mapped to an item in the file map, such as by identifying an item in the file map that includes the start byte of the element, and where there is preferably only one such mappable item in the file map (Step 604). If the element corresponds to the item, such as a one-to-one correspondence where the start address and size of the element are equivalent to the start address and size of the corresponding item in the map, then a count that is associated with the mapped element is incremented (Step 606), and the identity of the set that includes the mapped element, such as the block that included the data request, is recorded in association with the element, such as by setting a pointer that is associated with the count to point to the block (Step 608). If the element does not correspond to the item in a one-to-one correspondence, such as if the start bytes and/or sizes of the element and the item do not match, processing may continue with the method described in FIG. 6B. Steps 602-608 are preferably repeated for each element in each set, in a manner to preferably obtain and map each element once and only once. For each element that was mapped in steps 602-608, the number of blocks that include that element is determined, such as by checking the count that is associated with that element (Step 610). If the element is included in each input set, such as if the count associated with the element has value of N, the element is preferably added to an output set that is reserved for elements that are common to all the input sets (Step 612). Otherwise, if the element is found in only one input set, such as if the count has a value of one, the identity of the input set that includes the element and that was recorded in step 608 is obtained (Step 614), and the element is preferably added to an output set corresponding to the input set, and that is reserved for elements that are unique to that input set (Step 616).

Reference is now made to FIG. 6B which is a simplified flowchart illustration of an exemplary method of operation of the system of FIG. 5, operative in accordance with an embodiment of the invention. The method of FIG. 6B relates to mapping an element of a set onto an item in a map where either start bytes and/or the sizes of the element and item are not equivalent. The method is described in the context of mapping a request for data onto a map for a data file. However, this is for illustration purposes only, and it may be noted that the method is applicable to a general mapping of elements onto a map of items, where the elements and items do not necessarily comprise discrete features. If the start byte of the map item is not the same as the start byte of the element, the map item is split into two items where one of the split items preferably has the same start byte as the element. For example, a first map item is defined starting from the start byte of the map item until the start byte of the element, and a second map item is defined starting from the start byte of the target element and including the remaining bytes of the target map item (Step 618). Thus, if a target element referencing bytes 100,000 to 150,000 is mapped onto a target map item for bytes 80,000 to 150,000, the target map item is split into a first map item with a start byte of 80,000 and a size of 20,000, spanning bytes 80,000 to 99,999, and a second map item with a start byte of 100,000 and a size of 50,000, spanning bytes 100,000 to 149,999. The first and second map items are preferably added to the map, along with any identifying attributes such as keys that identify the start bytes of the items, and their sizes (Step 620). Upon obtaining a map item with the same start byte as the element, if the map item is larger than the element, the map item is preferably split to produce a third map item whose size corresponds to the size of the element, and a fourth map item including any portion of the map item after the last byte of the element, where the start bytes and sizes of the split items are added to the map, accordingly (Step 622). For example, if the map item references 80,000 bytes starting from byte 80,000 and the element references 50,000 bytes starting from byte 100,000, then the map item is subsequently split into three items: a first item spanning bytes 80,000 to 99,999 with a start byte of 80,000 and size of 20,000, a second item spanning bytes 100,000 to 149,999 with a start byte of 100,000 and a size of 50,000 and corresponding in a one-to-one correspondence with the element, and a third item spanning bytes 150,000 to 159,999, with a start byte of 150,000 and size of 10,000. Conversely, if the element is larger than the map item, the element is split into a first element starting from the first byte of the element until the last byte of the map item and corresponding to the map item, and a second element including any remaining bytes of the target element after the last byte of the map item (Step 624). For example, if an element referencing 50,000 bytes starting from byte 100,000 is mapped onto a map item spanning 30,000 bytes starting from byte 100,000, the element is split into a first element from 100,000 to 129,999 corresponding to the map item, and a second element from 130,000 to 149,999.

Processing preferably continues for the second element at step 604 of FIG. 6A. Upon performing the above splitting steps, if the element and the map item have the same start byte and size, the method preferably resumes from Step 606 in FIG. 6A. It may be noted that the method of FIG. 6B is implemented prior to, in conjunction with, or subsequent to the method of FIG. 6A. It may be noted that any of the splitting steps described in FIG. 6B is preferably implemented in a manner to produce split items that exactly span the original item, and that the items thus span the file and maintain a one-to-one correspondence with the data stored in the file. Furthermore, any attributes associated with an item prior to a split, such as a count or an identifier of a set that includes the element that is mapped to the item, are associated with any items resulting from the split. It may further be noted that prior to performing the method of FIGS. 6A-6B, any redundancies that appear in the block definitions, such as multiple references to the same data range, are preferably resolved using any known method. In addition, multiple elements, such as data segments, that are within a predefined range and/or that are defined consecutively in the set, or block, are preferably joined to form a single element, along with any attributes that are associated with the multiple elements. It may further be noted that the order of the elements in the sets that result from implementing the method of FIGS. 6A-6B is preferably determined in accordance with one or more predefined criteria, and that the resulting sets are maximal in a sense that elements may be removed from any of the sets in. It may further be noted that the above method is applicable to non-integer ranges.

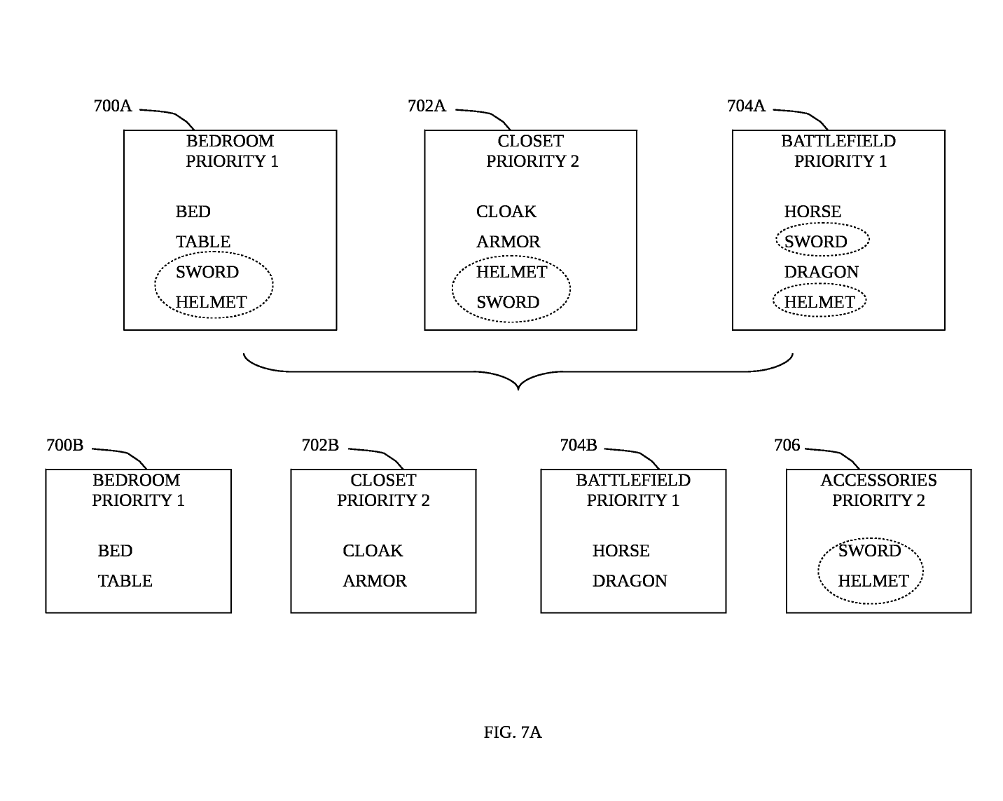

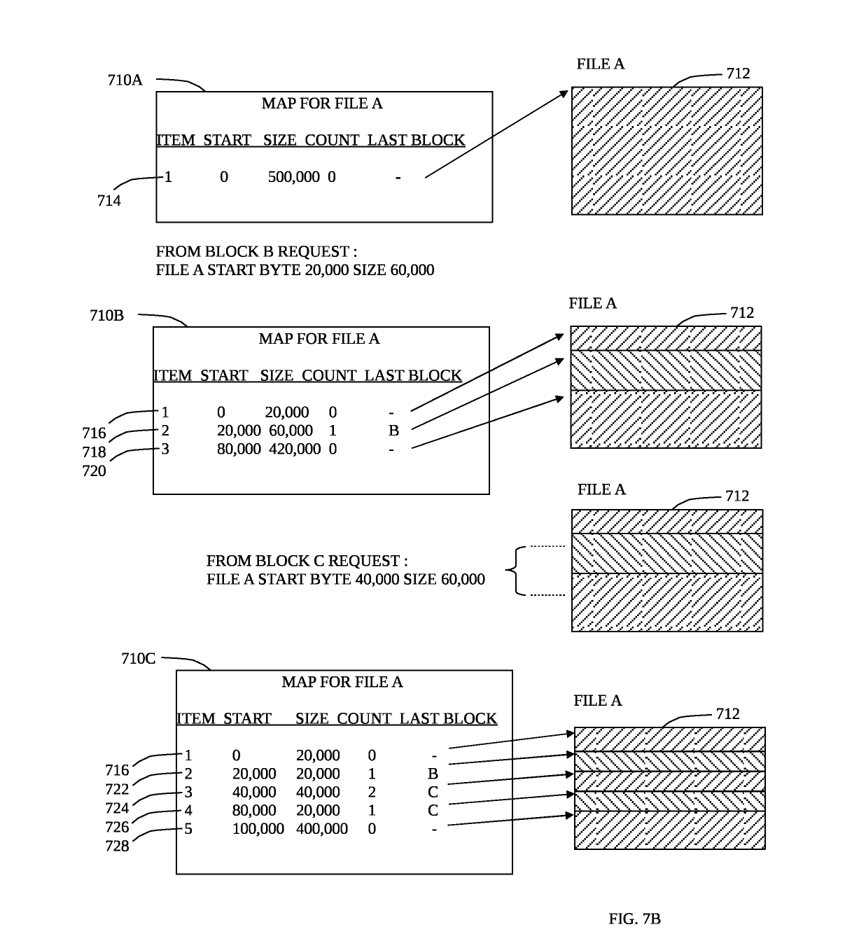

Reference is now made to FIG. 7A which is an exemplary result of an implementation of the method of FIGS. 6A-6B. Three blocks are shown: a bedroom block 700A, a closet block 702A, and a battlefield block 704A. Bedroom block 700A includes requests for four images: bed, table, sword and helmet; closet block 702A includes requests for four images: cloak, armor, helmet and sword; and battlefield block 704A includes requests for four images: horse, sword, dragon, and helmet. Prior the implementation of the method of FIG. 6A, if a request for the sword image is intercepted, any subsequent rules for retrieving any of the other images in blocks 700A, 702A, and 704A are disabled to avoid retrieving data that are not required by the application. However, upon implementing the method of FIG. 6A, four blocks are shown, each of which are comprised of unique requests: bedroom block 700B includes requests for the bed and table images, closet block 702B includes requests for the cloak and armor images, battlefield block 704B includes requests for the horse and dragon images, and a new accessories block 706 includes requests for the sword and helmet images, which were the requests common to blocks 700A, 702A, and 704A. Upon intercepting a request for the sword, a rule to download accessories block 706 is activated and the helmet is retrieved. It may be noted that a flag can be set to determine the order of the requests in accessories block 706, such as a random order, or an average order. For example, if the flag is set to the average order, accessories block 706 will first request the sword image, and then the helmet image. Alternatively, if the flag is set to order according to the highest priority, since closet block 702A has a higher priority than either bedroom block 700A or battlefield block 704A, accessories block 706 first requests the helmet image and then the sword image, in accordance with the order of the requests in closet block 702A. As another example, two sets, A and B, comprising requests for data within specified ranges are shown, where some requests have attributes associated with them.

| Set A | Set B |
|---|---|
| 100,000 -> 125,000 | 190,000 -> 210,000 (attribute × attached) |
| 75,000 -> 95,000 | 77,000 -> 80,000 |
| 200,000 -> 3,000,000 | 110,000 -> 115,000 |
| 0 -> 1025 | 4,000,000 -> 5,000,000 |
| | 0 -> 1025 |

Upon applying the method of FIG. 6A, sets A and B are compared, and requests for common data ranges are extracted, resulting in three sets: a new set AB comprising requests that are common to both sets A and B, a set A′ comprising requests that are unique to A, and a set B′ comprising requests that are unique to B. In the above example, set A includes a request for range 100,000 to 125,000, and set B includes a request for range 110,000 to 115,000. Although the two requests are not identical, the request from set B is a subset of the request from set A, and thus, common to both A and B. The request is extracted from set B, and only the portion of the request that is common to both A and B is extracted from set A, resulting in the addition of the common request 110,000→115,000 to set AB. Two smaller requests are added to set A′ for ranges that are unique to A: 100,000→100,000 and 115,000→125,000. As another example, set A includes a request for range 200,000-→3,000,000, and set B includes a request for range 190,000→210,000. Upon applying the method of FIG. 6A, the portion of the non-matching requests that is common to both sets A and B, 200,000→210,000, is extracted from both sets and added to set AB, a request for the remaining data that are unique to set A, 210,000→3,000,000, is added to set A′, and a request for the remaining data that are unique to set B, 190,000→200,000, are added to set a B′. The requests in sets A and B are preferably compared and matched without regard to the order in which they appear. The order of the requests in the new set AB is preferably determined in accordance with one or more predefined parameters.

### Set AB

110,000→115,000 (order rank based on Set A)
200,000→210,000 (order rank based on Set B)—(attribute X still attached)
77,000—80,000 (order rank 2 from both Sets A and B)
0→1025 (order rank 4 from Set A)

| Set A′ comprising requests | |
|---|---|
| unique to A | Set B′ comprising requests unique to B |
| 100,000 → 110,000 | 190,000 → 200,000 |
| 115,000 → 125,000 | 4,000,000 → 5,000,000 |
| 75,000 → 77,000 | |
| 80,000 → 95,000 | |
| 210,000 → 3,000,000 | |

Reference is now made to FIG. 7B which is another exemplary result of an implementation of the method of FIGS. 6A-6B. A file map 710A is shown for a file 712. Prior to mapping any requests for file 712, map 710A includes a single item 714, starting from the beginning of the file at byte 0, and spanning the size of the entire file of 500,000 bytes. A first request is obtained from block B for 60,000 bytes starting from byte 20,000 from File A 712. As shown in file map 710B, item 714 is split according to the method described in FIGS. 6A-6B, into three sections, a first item 716 starting from byte 0 of size 20,000, a second item 718 starting from byte 20,000 for 60,000 bytes and corresponding to the request, and a third item 720 starting from byte 80,000 of size 420,000. Item 718 is mapped to the first request, it's count is incremented by one, and the last block field is set to Block B which is the last block that requested that data. A second request is obtained from block C for 60,000 bytes starting from byte 40,000. This request partially overlaps both items 718 and 720 in file map 710B. As shown in file map 710C, since item 718 includes the start byte of the second request, item 718 is split into two items: item 722 starting from byte 20,000 of size 20,000 and maintaining the previous count and last-block attributes, and item 724 starting from byte 40,000 of size 40,000 which is mapped to the second request, where the indices of the items are updated, accordingly. Thus the count of item 724 is incremented and now has a value of 2, and the last block attribute is set to block C. However, the request extends beyond item 724, and thus, the request is split into two portions, where the first portion of the request maps onto item 724, and the second portion of the request has a start byte of 80,000 and a size of 20,000, and thus maps onto item 720 in map 710B, and which also has a start byte 80,000. Since item 720 is larger than the second request portion, item 720 is split into items 726 and 728 in map 710C, where item 726 is mapped onto the second request portion and thus its count is incremented and its last block attribute is set to block C. Item 748 maps onto the remaining portion of the file. Thus by examining the file map, it is possible to determine if, and how many times a portion of a file has been referenced. By examining the count and last block attributes in map 730, the file can be divided into three portions: a portion that is unique to block B and that includes map items with a count of 1 and a last block of B, and starting from byte 20,000 with a size of 20,000 bytes; a portion that is common to both blocks B and C with a count of 2 which is equivalent to the number of input blocks, and starting from byte 40,000 with a size of 40,000 bytes; and a portion that is unique to block C with a count of 1 and a last block of C, starting from byte 80,0000 for 20,000 bytes.

As another example, the method described in FIGS. 6A-6B may be applied to network, or traffic analysis. Multiple routes traveled over path segments are recorded, and the number of traversals, or travel frequency, over each path segment is tallied. Segments are scored in accordance with their tally. For example, a frequently traveled path segment receives a high score and rarely traveled segment receives a low score. The tally system can be used in conjunction with the method of FIG. 6A as follows: path segments with a tally of one are unique and are not extracted from the sets, path segments with a tally that is greater than one are extracted. If the tally of the extracted element is equal to the number of sets, then the extracted path segment is common to all the routes, and is added to the overlap set. This could be applied to a road traffic scenario, where road segments that are frequently traveled, and therefore have a high score are identified as requiring higher traffic enforcement, or alternatively, a higher commercial value.

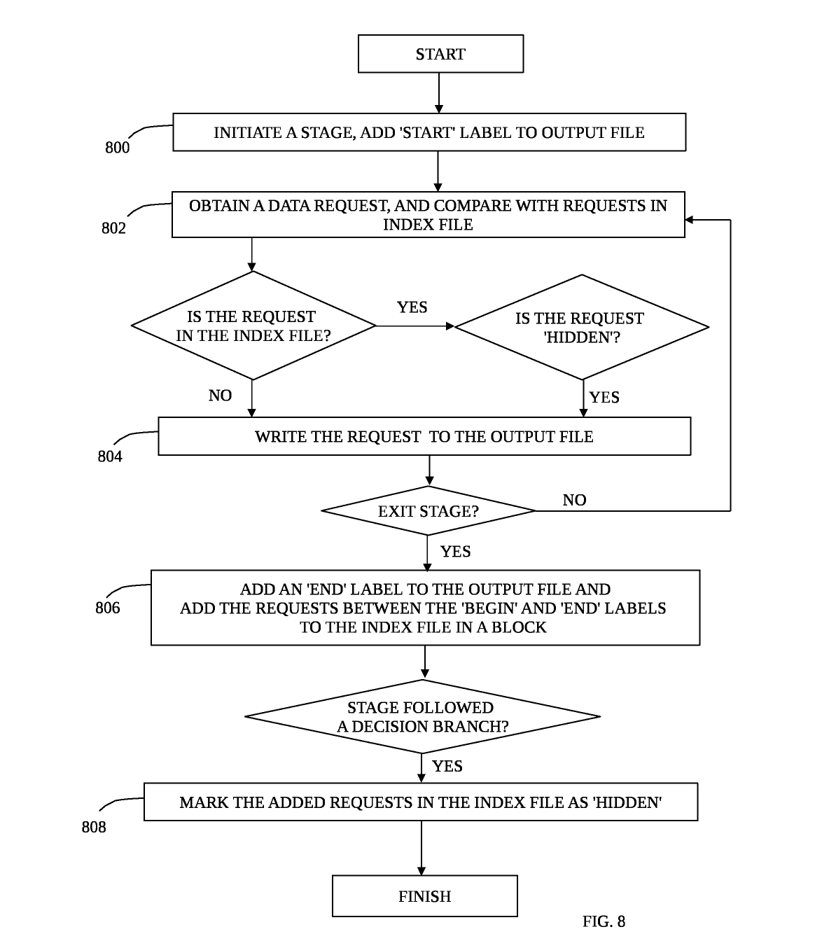

Reference is now made to FIG. 8 which is a simplified flowchart illustration of an exemplary method of operation of the system of FIG. 5 relating to defining blocks, operative in accordance with an embodiment of the invention. The method of FIG. 8 may be employed for defining blocks for inclusion in an index file. Since the software application is decision-oriented, each instantiation of the software application typically results in a different sequence of data requests, resulting in a different sequence for placing the blocks defined in the index file on the priority queue. For example, in a first instantiation, a user descends down a main hallway and chooses to enter a room A which includes images of a portrait and a cabinet, resulting in requests for blocks for displaying the main hallway and room A. Whereas in a second instantiation, the user descends down the main hallway and chooses to enter a room B which includes images for a table and the same cabinet, and which results in requests for blocks for displaying the main hallway and room B. However, to avoid requesting data that has already been retrieved, data requests are typically not included in more than one block. In the above example, if room A is selected in the first instantiation, the request for the cabinet is included in the block defined for room A in the index file, and therefore, the cabinet is not included in a block defined in the index file for room B, which is selected in a second instantiation, resulting in an insufficient block definition for displaying room B. This problem is solved by adding a ‘hidden’ tag to requests that are associated with a decision branch in the application.

Thus the method of FIG. 8 may be used to define blocks in the index file in a manner that enables requesting data that are required for a particular instantiation of the application, while averting requesting data that are unnecessary for that instantiation. The application is preferably executed in a mode that enables defining blocks during execution, such as by recording requests for data in an output file, and by adding labels to the output file via a user interface, such as by pressing an F-key. Upon initiating a stage in the application, a START STAGE tag is added to an output file via the user interface (Step 800). Upon obtaining a data request, the request is compared with previously intercepted data requests that have already been included in the index file (Step 802). If the new request is not present in the index file or the request is present in the index file but is marked as ‘hidden’, the request is written to the output file (Step 804). This process is repeated until the end of the stage, whereupon an END STAGE tag is added to the output file via the user interface. The requests in the output file that fall between the START STAGE and END STAGE tags are added to the index file in a block that is associated with the stage (Step 806). If the stage was initiated following a decision branch in the execution flow of the application, such as if the user selected to enter one of two rooms, any requests included the block that was added to the index file are marked as ‘hidden’ (Step 808). This method is preferably repeated for all possible stages and all possible decision branches in the decision-oriented application. In the above example, if room A is selected in a first instantiation, the portrait and cabinet requests are included in the block for room A. In a second instantiation where the user selects to enter room B, without the ‘hidden’ tag, these requests would be omitted in a block definition for room B, even if those data are required for displaying room B. Thus, by using the ‘hidden’ tag in the index file, blocks are defined for parallel logical paths in the application, and required data is requested, while non-required data is not requested.

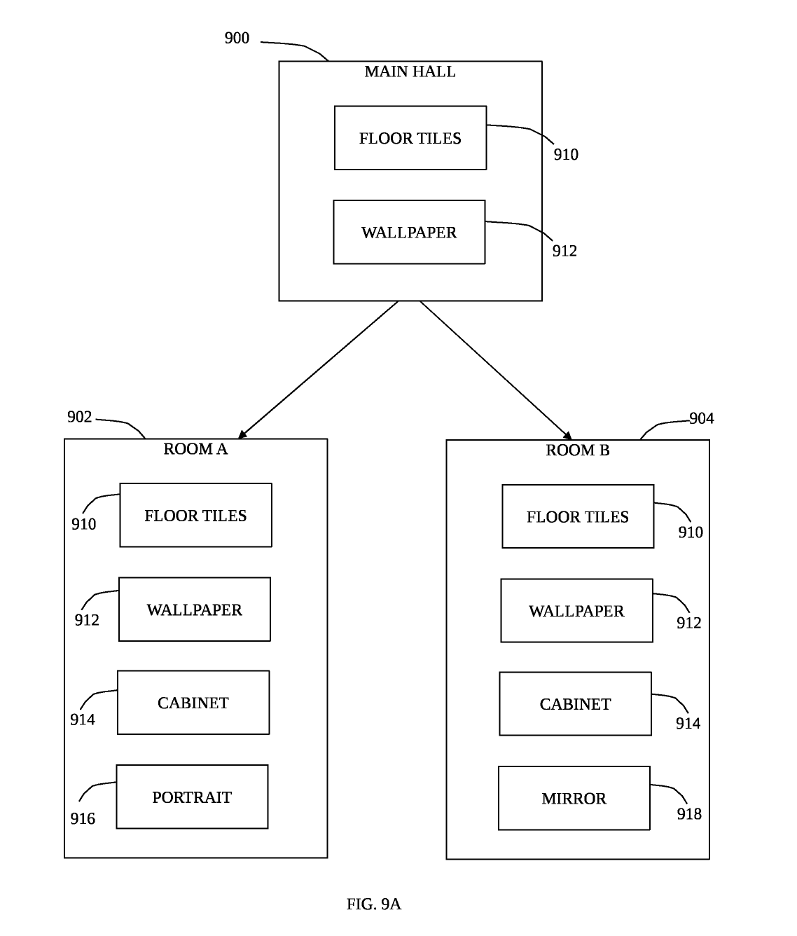

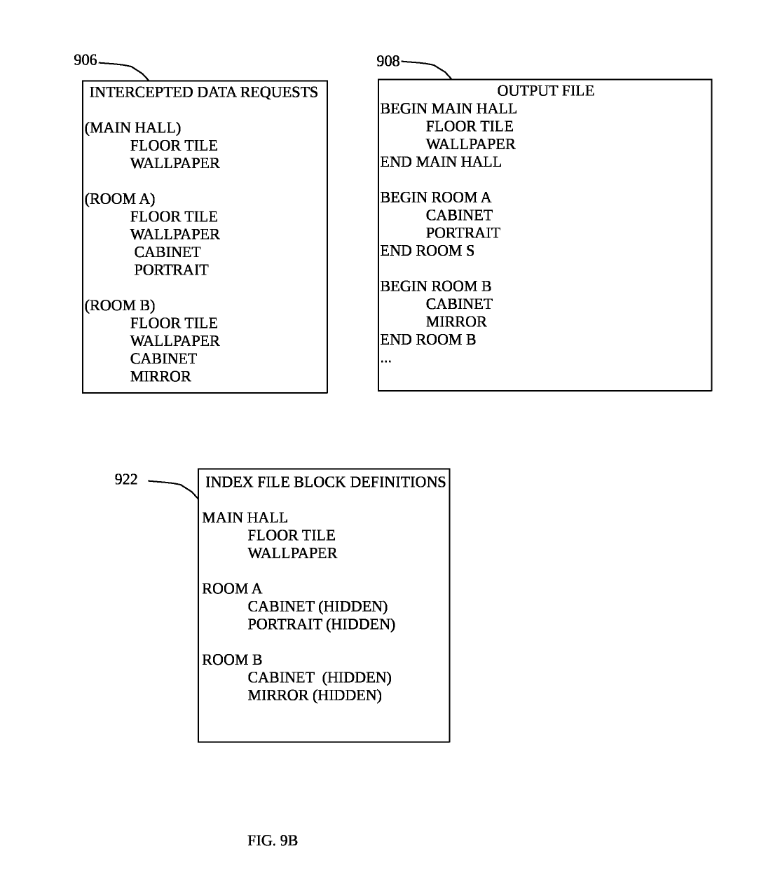

Reference is now made to FIGS. 9A-9B, which, taken together, illustrate exemplary results of an implementation of the method of FIG. 6B. FIG. 9A shows a sequence of data requirements for a decision point in the application, where a main hall stage 900 can lead to either of two branches, room A 902, or room B 904. FIG. 9B shows the intercepted data requests 906 resulting from an execution of the application, an output file 908 for recording intercepted requests, and the index file 922 resulting from an application of the method of FIG. 8. An operator defining index file 922 executes the application and progresses down a required stage in the game, such as main hall stage 900 which displays data referenced by floor tiles block 910 and wall paper block 912. The intercepted data requests 906, shown in FIG. 9B, are compared with requests from the index file 922. Since index file 922 does not yet include the floor tile block 910 or wall paper block 912, the requests are recorded in an output file 908, shown in FIG. 9B, between the labels Begin Main Hall and ‘End Main Hall’. The requests between the labels are retrieved from output file 908, grouped into a Floor Tile block and Wall Paper block, which are added to index file 922 in association with the Main Hall stage of the game. Referring back to FIG. 9A, the game presents the operator with a choice: progress to room A 902 or to room B 904. The operator selects room A 902, which includes data referenced by floor tiles 910 and wall paper 912 that were displayed in the main hall, and additionally, data referenced by cabinet block 914 and portrait block 916. The operator preferably presses an F-key, adding a label begin room A′ to output file 908. Since index file 922 already includes block definitions for floor tiles 910 and wall paper 912 and they are not hidden, only requests for cabinet block 914 and portrait block 916 are recorded in output file 908. Upon exiting room A 902, the operator preferably presses the F-key, adding the label ‘end room A’ to output file 908. The operator identifies the data requests located between labels begin room A′ and ‘end room A’ in output file 908, and adds cabinet block 914 and portrait block 916 definitions to index file 922 in association with room A. Additionally, since entering room A resulted from a decision made by the user playing the game, a ‘hidden’ label is added to both the cabinet block 914 and portrait block 916 definitions for room A in index file 922. The operator continues playing the game and selects to enter room B 904, which displays data referenced by floor tiles block 910, wall paper block 912, cabinet block 914 as well as a mirror block 918. The operator preferably selects the F-key, adding a label begin room B′ to output file 908. As described above for room A, floor tiles block 910 and wall paper block 912 appear in index file 922, and are therefore not recorded in output file 908. Similarly, since mirror block 918 does not appear in index file 922, these requests are recorded in output file 908. However, although requests for cabinet 914 are present in index file 922, they are labeled as ‘hidden’, and therefore they are also recorded, a second time, in output file 908. Upon exiting room B, the operator preferably presses the F-key, adding the label ‘end room B’ to output file 908. The operator identifies the data requests located between labels begin room B′ and ‘end room B’ in output file 908, and adds cabinet block 914 and mirror block 918 to index file 922 in association with room B. Thus, a user playing the game with index file 922 downloads floor tiles block 910 and wallpaper block 912 upon entering the main hall. Upon selecting the room A, cabinet block 914 and portrait block 916 are downloaded. Alternatively, if room B is selected, cabinet block 914 and mirror block 918 are downloaded.

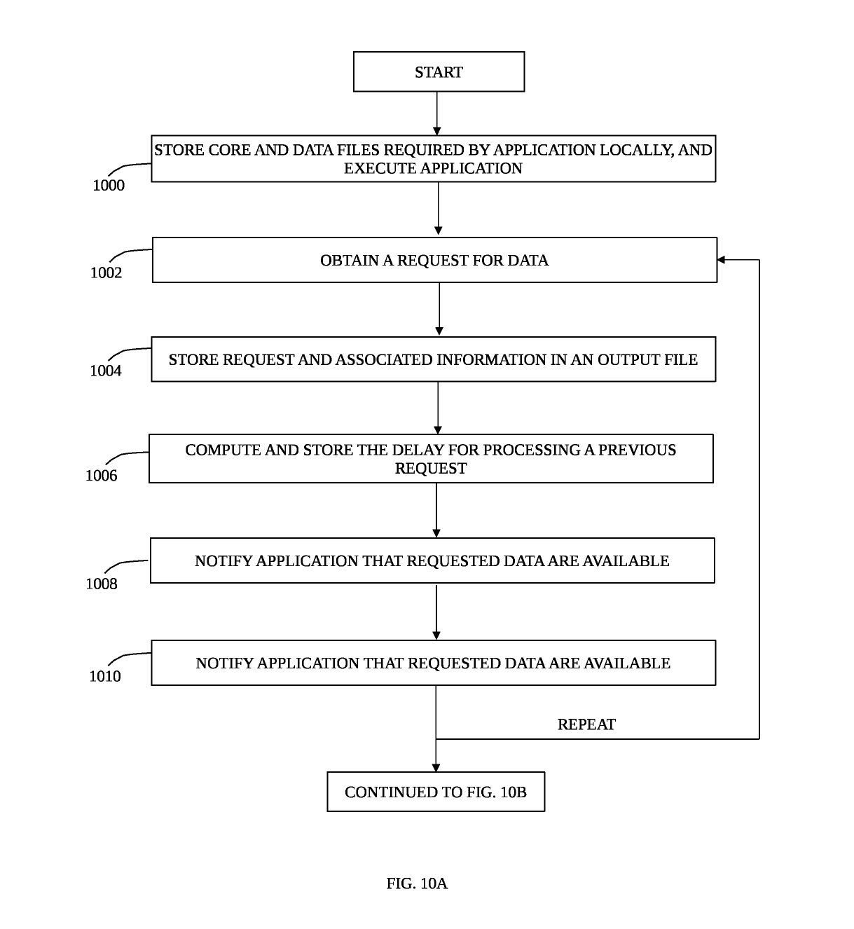

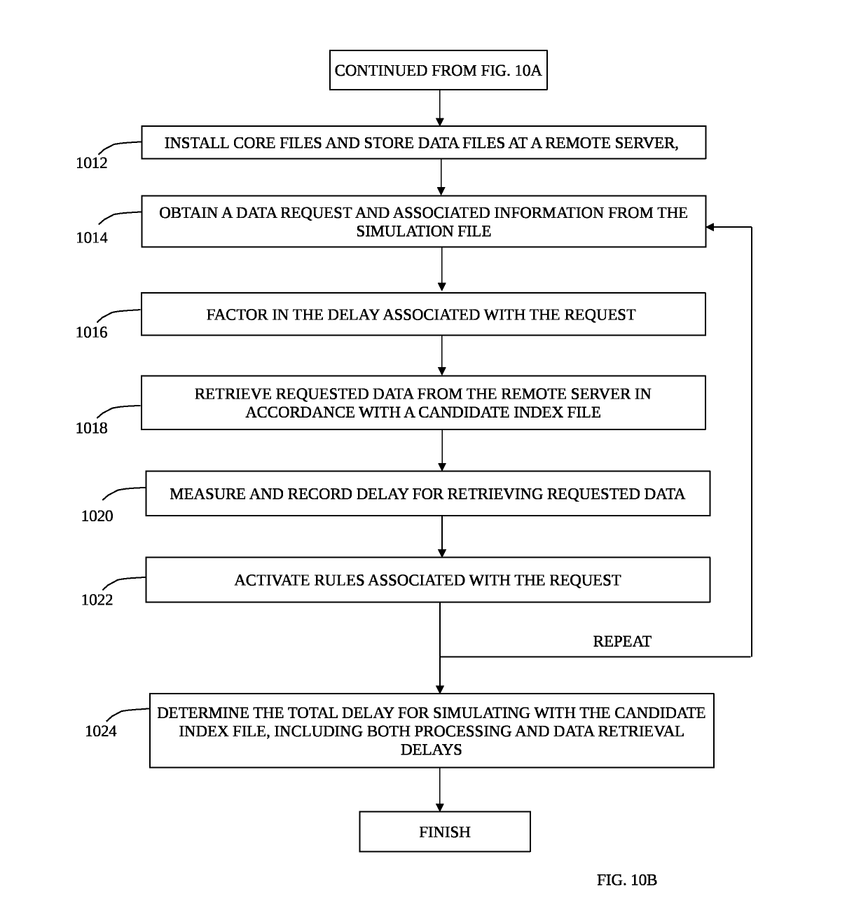

Reference is now made to FIG. 10A which is a simplified flowchart illustration of an exemplary method of operation of the system of FIG. 5 relating to evaluating a candidate index file, operative in accordance with an embodiment of the invention. In the method of FIG. 10A, a simulation file is created for an execution of the application as follows. The application, including the core and data files, is installed locally, and the application is executed (Step 1000), such as in accordance with an index file. A request for data by the application is obtained (Step 1002), and information that is associated with the obtained request, such as the filename, start address, the size of the request, and the time that the request is obtained are stored in the simulation file (Step 1004). The delay between responding to a previously obtained request and obtaining the current request is calculated, such as in milliseconds, using information obtained from the simulation file in association with the previous request, and the delay is stored in the simulation file in association with the previously obtained request (Step 1006). For example, if a response to the previously obtained request is given at time T1, and the currently obtained request is received at time T2, the delay is computed as T2−T1. The requested data is sent to the application, such as by notifying the application that the data are available (Step 1008) and the time for completing the processing of the obtained request is recorded in the simulation file (Step 1010). Steps 1002 to 1010 are preferably repeated until the application terminates, and the method resumes in accordance with FIG. 10B.

Reference is now made to FIG. 10B which is a simplified flowchart illustration of an exemplary method of operation of the system of FIG. 5 relating to evaluating a candidate index file, operative in accordance with an embodiment of the invention. In the method of FIG. 10B, a simulation of the application is executed in a manner to preferably maintain a constant delay for processing requests in accordance with the simulation file created by the method of FIG. 10A and measure the delay for retrieving the requested data from a remote storage device in accordance with a candidate index file, where the candidate index file may be the index file of method of FIG. 10A, a modification of the index file of FIG. 10A, or any other index file obtained using any conventional method. The core files are installed locally, and the data files are stored remotely (Step 1012). A request for data is preferably obtained, such as from the simulation file, as well as any information that is associated with the request, such as the recorded delay for processing the request (Step 1014). The processing delay is factored, such as by waiting for the duration of the delay that was obtained with the request in Step 1014 (Step 1016). The requested data is retrieved in accordance with the block definitions, rules, and any additional attributes defined in the candidate index file (Step 1018). The delay for retrieving the requested data from the remote storage device is measured and recorded (Step 1020). Any rules associated with the requested data are activated (Step 1022), such as rules that place additional blocks on the priority queue, or that change a priority for a block that is on the queue. Step 1014-1022 are preferably repeated for the all the requests recorded in the simulation file. The total delay for simulating the application with the candidate index file is determined, where the total delay preferably includes the processing delays obtained from the simulation file in association with the requests, as well as the delays for retrieving data from the remote server in accordance with the obtained requests (Step 1024). This method is preferably repeated for any number of candidate index files. In this manner, one or more candidate index files are preferably modified, and the effect of the modification on the delay for retrieving data from a remote storage device in accordance with a first candidate index file is measured and compared with a similar delay for retrieving the same data in accordance with a second candidate index files, where the delay for processing the requested data is preferably constant for the two different candidate index files.

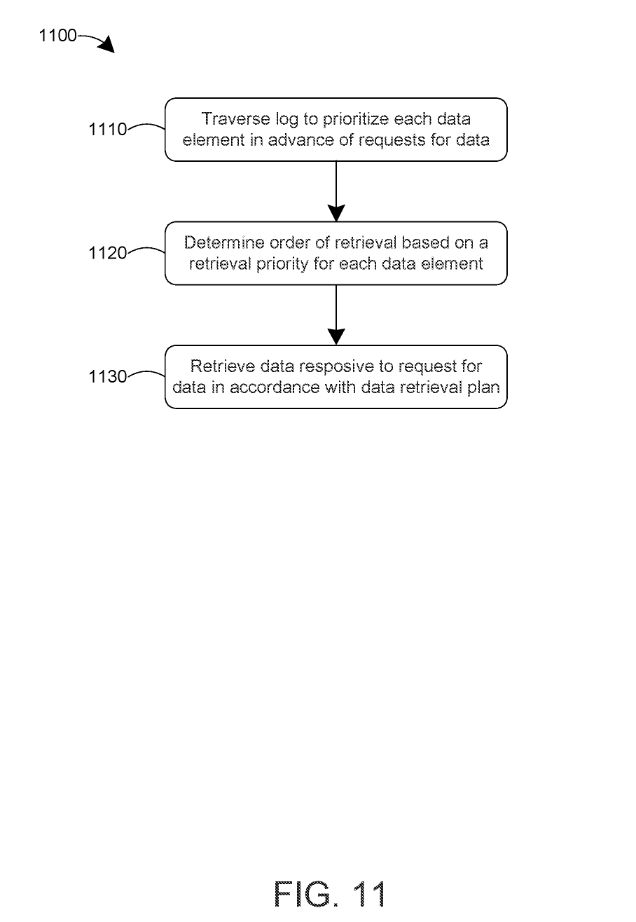

Reference is now made to FIG. 11 which is a simplified flowchart 1100 illustration of an exemplary method for determining an order of data retrieval based on a data retrieval plan, according to one or more embodiments of the invention. The method illustrated in FIG. 11 can be performed on one or more of the systems, devices, and/or architectures described herein. In step 1110, a log is traversed to prioritize within the log each data element in advance of requests for data to be made by a computer software application. In some embodiments, the log is the execution log 308, described above, that records requests for data made by an executed software application during its execution. In other embodiments, the log is a list of data elements that was compiled prior to the execution of the computer software application. In the latter case, the log can be included or associated with the core files of the computer software application, which the client computer or other client device (e.g., computer 102) (in general, client computer) downloads from a server (or other data storage location). In yet other embodiments, the log is provided by the server (or other data storage location) based, at least in part, on a user's interaction with the computer software application. For example, when the user completes a first level of a video game, the server (or other data storage location) can provide the client computer with a log that includes the data elements for the second level of the game. Thus, the log can be compiled during or prior to the execution of the computer software application. The traversal of the log can occur during execution of the computer software application or at a time other than during the execution of the computer software application. For example, the traversal can occur when the user has stopped playing a video game and the client computer operating system can traverse the log as a background task. In addition or in the alternative, the traversal can occur before the user opens or starts the computer software application (i.e., prior to its execution), for example when the computer software application (e.g., core files) are downloaded/retrieved from the server (or other data storage location). In yet another alternative, the server can traverse the log before the client computer downloads the computer software application (e.g., core files) from the server (or a data storage location associated with or managed by the server).

During traversal, each data element is prioritized based on one more factors. For example, the data elements can be prioritized based, at least in part, on their retrieval priority, which may be set by the developer or may be determined based on a default retrieval priority, as discussed herein. The data elements can also be prioritized based, at least in part, on one or more rules which may be associated with each data element or data block, as discussed above. The data elements can also be prioritized based, at least in part, on the size of each data element. For example, data elements that have larger sizes may be prioritized higher or lower than data elements having smaller sizes. In another example, data elements having larger sizes are distributed in priority, which may reduce any latency the user may experience due to download/retrieval times. The data elements can also be prioritized based, at least in part, on one or more tags associated with each data element or data block. The tags can group the data elements based on a common tag. Each group of data elements can be prioritized, for example, based on the user's interaction with the computer software application. For example, the computer software application can determine based on the user's interaction history that the user may need certain types of data for the computer software application. The grouping can also be prioritized based on the user's interaction with a game—e.g., level 2 is downloaded before level 3, etc.

In step 1120, the order of the data retrieval is determined. The order of the data retrieval can be based on or more of the priority or grouping factors discussed above. For example the order of the data retrieval can be based, at least in part, on the retrieval priority, the size of each data element, and/or a tag or common tag. Some or all of these factors can be stored in the log and associated with each data element. The order of the data retrieval can be determined during the execution of the computer software application or at a time other than during the execution of the computer software application (e.g., prior to or after the execution of the computer software application).

In step 1130, data responsive to any of the requests for data, made by the computer software application, is retrieved from the server (or other data storage location). Some or all of the data requested are identified in the log as the data elements, which were prioritized as discussed above in steps 1110 and 1120. The retrieval can be performed in accordance with a data retrieval plan associated with the data requested by the computer software application. For example, the data retrieval plan can indicate that certain data elements are needed immediately by the computer software application (e.g., the user moved into a room in a game that needs certain data to render the room) while other data elements (e.g., data associated with surrounding rooms, or with the next level of the game) can be retrieved later. The data retrieval plan can also determine when it is appropriate to retrieve data elements that have a common tag associated therewith (e.g., to load the next level of a game, etc.). The data retrieval plan can also retrieve data based on the user's actions and/or based on anticipated user actions (e.g., based on the user's interaction history with the computer software application). The data retrieval in step 1130 can occur during the execution of the computer software application or at a time other than during the execution of the computer software application (e.g., prior to or after the execution of the computer software application).

In some embodiments, the retrieval priority of a data element can be modified. For example, a developer may adjust the priority of a data element. In another example, the priority of a data element can be modified by the server, for example after a tag is associated with the data element and/or after the server determines the size of other data elements that will be retrieved concurrently. For example, if the relative size of the data element is large compared to the other data elements that will be retrieved concurrently, the server can increase or decrease the retrieval priority, as discussed above.

In some embodiments, the data retrieved corresponds to one or more of the supplemental data files (e.g., data files 110) used by the core files for the computer software application. The supplemental data files can include features, functionality, media resources (e.g., an audio file and/or a video file), and/or other data that are used by the computer software application. The computer software application may need the supplemental data files in response to a user's interaction with the predefined portion (i.e., the core files 108) of the computer software application, or in response to a user's interaction with the computer software application after one or more of the supplemental data files have been retrieved (e.g. retrieving data files for level 3 of a game in response to the user completing level 2). The supplemental data files can also include supplemental functionality that the user may purchase or request. In some embodiments, the predefined portion (i.e., the core files 108) of the computer software application is configured to operate in or achieve a first state and the predefined portion, together with one or more data files, is configured to operate in or achieve a second state. The first state can correspond to the initial installation of the computer software application on the client computer. The second state can correspond to the initial installation of the computer software application with additional data or functionality provided by the supplemental data files. Thus, the computer software application can be modularly created with core files and supplemental data files.

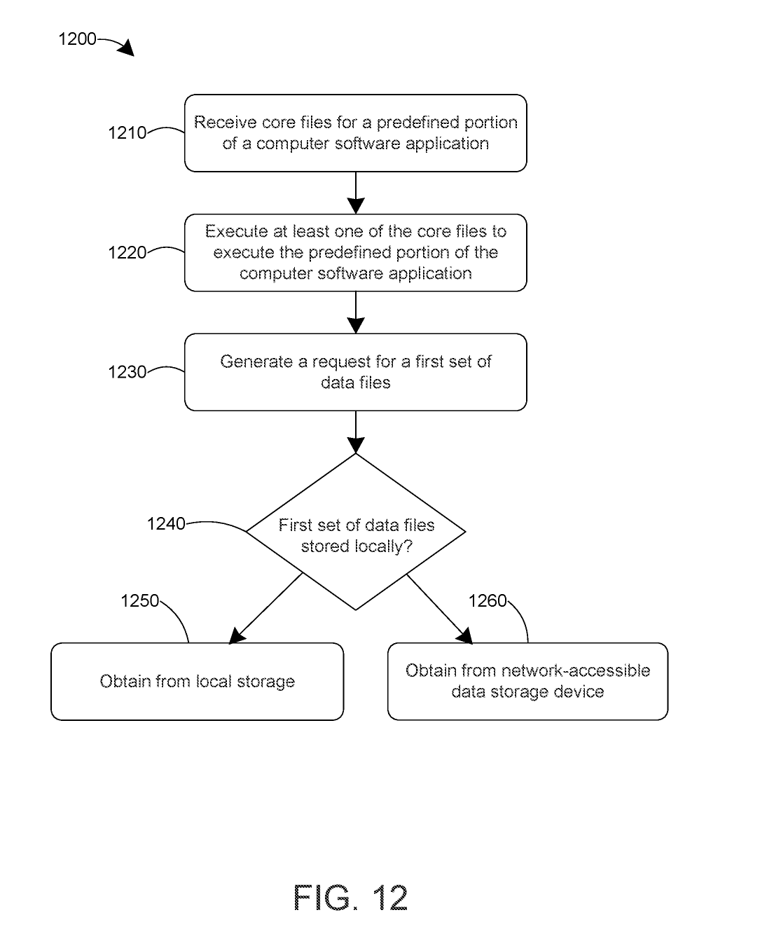

Reference is now made to FIG. 12 which is a simplified flowchart 1200 illustration of an exemplary method for retrieving a computer software application on a client device, according to one or more embodiments of the invention. The method illustrated in FIG. 12 can be performed on one or more of the systems, devices, and/or architectures described herein. In step 1210, the client device receives, from a server (or other data storage device) in network communication with the client device, core files (e.g., core files 108) for a predefined portion of a computer software application. The computer software application includes both core files and supplemental data files, as discussed above.

In step 1220, the client device executes at least one of the core files to cause the execution of the computer software application. For example, the core files can include an executable file (e.g., a file with an “.exe” or other suffix) that causes at least the predefined portion of the computer software application to execute. In some embodiments, the predefined portion of the computer software application executes and runs with the appearance, to the user, that the entire computer software application, including the supplemental data files, have already been downloaded.

In step 1230, a request for a first set of the supplemental data files is generated during the execution of at least the computer software application (e.g., the predefined portion of the computer software application). As discussed above, the supplemental data files can provide features, functionality, media resources (e.g., an audio file and/or a video file), and/or other data that are used by the computer software application. Thus, the first set of supplemental data files can provide one or more features, functions, media resources, and/or other data for the computer software application. The first set of supplemental data files can be requested and retrieved in response to a user's interaction with the computer software application, as described above.

In step 1240, the client device determines whether the first set of supplemental data files, requested in step 1230, are stored locally. If they are stored locally, in step 1250 client device (e.g., the computer software application and/or client device operating system) retrieves the files from local memory for use by the computer software application. If they are not stored locally, in step 1260 the client device retrieves the first set of supplemental data files from a network-accessible data store device, such as a server, in network communication with the client device. The data retrieval in steps 1250 and/or 1260 can occur during execution of the computer software application or at a time other than during execution of the computer software application (e.g., after the cores files are downloaded and installed but before the computer software application is executed on the client device).

In some embodiments, the client device determines whether placeholder files (e.g., placeholder files 110′, discussed above) for the first set of supplemental data file are stored locally on the client device. The existence of placeholder files indicates that the first set of supplemental data files are not stored locally on the client device. The placeholder files can include metadata that indicate the size, file type, or other information of the corresponding first set of supplemental data files. In some embodiments, the first set of supplemental data files are retrieved according to the retrieval priority associated with the first set of supplemental data files and/or the retrieval priority associated with each file in the first set of supplemental data files. The retrieval priority can be determined based on the metadata in the placeholder files, the retrieval priority in a log (e.g., as described in FIG. 11), or based on a default retrieval priority. The first set of supplemental data files can also be retrieved in accordance with a data retrieval plan, as discussed above.

Additional requests for supplemental data and/or supplemental data files can be generated, for example during execution of the computer software application. For example, the additional requests may result from the user's interaction with a game (e.g., advancing to the next level), the user's requests for additional functionality, and/or they may be automatically generated (e.g., as background tasks after the initial core files are downloaded and/or in response to a user's interaction with the computer software application). For each request for supplemental data and/or supplemental data files, the flow chart 1200 repeats through steps 1230 and 1240 and, depending on whether the supplemental data file is stored locally, step 1250 or 1260.

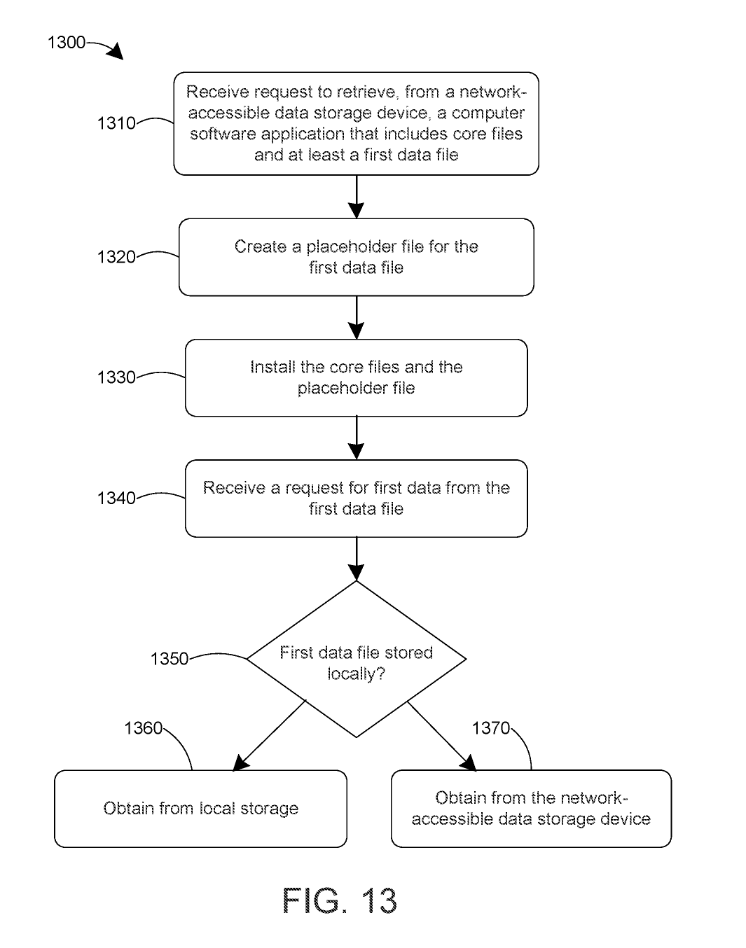

Reference is now made to FIG. 13 which is a simplified flowchart 1300 illustration of an exemplary method for installing a computer software application on a client device, according to one or more embodiments of the invention. The method illustrated in FIG. 13 can be performed on one or more of the systems, devices, and/or architectures described herein. In step 1310, the client device receives a request to retrieve a computer software application. The computer software application is stored on a data storage device, such as a server, in network communication with the client device. The computer software application includes (1) a set of core files including a core file executable and (2) at least a first and/or other supplemental data file(s) that can be used by the core file executable. The core file executable is a core file that, when run or executed by the client device, causes the client device to run or execute at least a predefined portion of the computer software application associated with the core files. As discussed above, the supplemental data file(s) can provide features, functionality, media resources (e.g., an audio file and/or a video file), and/or other data that are used by the computer software application.

In step 1320, the client device creates at least a first and/or other placeholder file(s), that corresponds to the at least the first and/or other supplemental data file(s), in its local storage in place of the first and/or other supplemental data file. In other embodiments, the network-accessible storage device includes both supplemental files and placeholder files, in which case the placeholder file(s) is/are retrieved by the client device in step 1310.

In step 1330, the client device installs the core files and first and/or other placeholder file(s) locally, for example in a local memory device in the client device or in communication with the client device. In step 1340, the client device receives a request from the computer software application for first data from the first and/or other data file(s). The request can correspond to or can be in response to a user's request for additional functionality for the computer software application or a user's interaction with the computer software application, for example while playing a game.

In step 1350, the client device determines whether the first and/or other data file(s), requested in step 1340, is/are stored locally. In some embodiments, the client device determines that a data file(s) is/are not stored locally by determining that a placeholder file(s) is stored locally in place of the requested data file(s). The existence of the placeholder file(s) can indicate, to the client device, that the requested file(s) is/are not stored locally. In some embodiments, the placeholder file(s) includes metadata that indicates that the requested file(s) is/are not stored locally. In addition or in the alternative, the metadata can indicate one or more properties of the requested data file(s), such as its/their size, file type, tags associated with the data file(s), etc.

If any of the data files are stored locally, in step 1360 the client device (e.g., the client device operation system and/or the computer software application) retrieves them from local storage (e.g., from a local memory device in the client device or from a local memory device in communication with the client device), for use by the computer software application. If any of the data files are not stored locally, in step 1370 the client device retrieves them from the network-accessible data storage device or server. In some embodiments, the data file(s) can be retrieved according to a retrieval priority and/or a data retrieval plan associated with the data or data elements associated with the data file(s), or associated with the data file(s) itself/themselves. The retrieval priority and/or data retrieval plan can be stored in a log of data files or data elements to be requested by the client device, as discussed above. The data retrieval in steps 1360 and/or 1370 can occur during execution of the computer software application or at a time other than during execution of the computer software application (e.g., after the cores files are downloaded and installed but before the computer software application is executed on the client device).

Additional requests for supplemental data and/or supplemental data files can be received, for example during execution of the computer software application. For example, the additional requests may result from the user's interaction with a game (e.g., advancing to the next level), from the user's requests for additional functionality, or from automatic generation (e.g., automatically generated as background tasks after the initial core files are downloaded and/or in response to a user's interaction with the computer software application). For each request for supplemental data and/or supplemental data files, the flow chart 1300 repeats through steps 1340 and 1350 and, depending on whether the supplemental data file is stored locally, step 1360 or 1370.

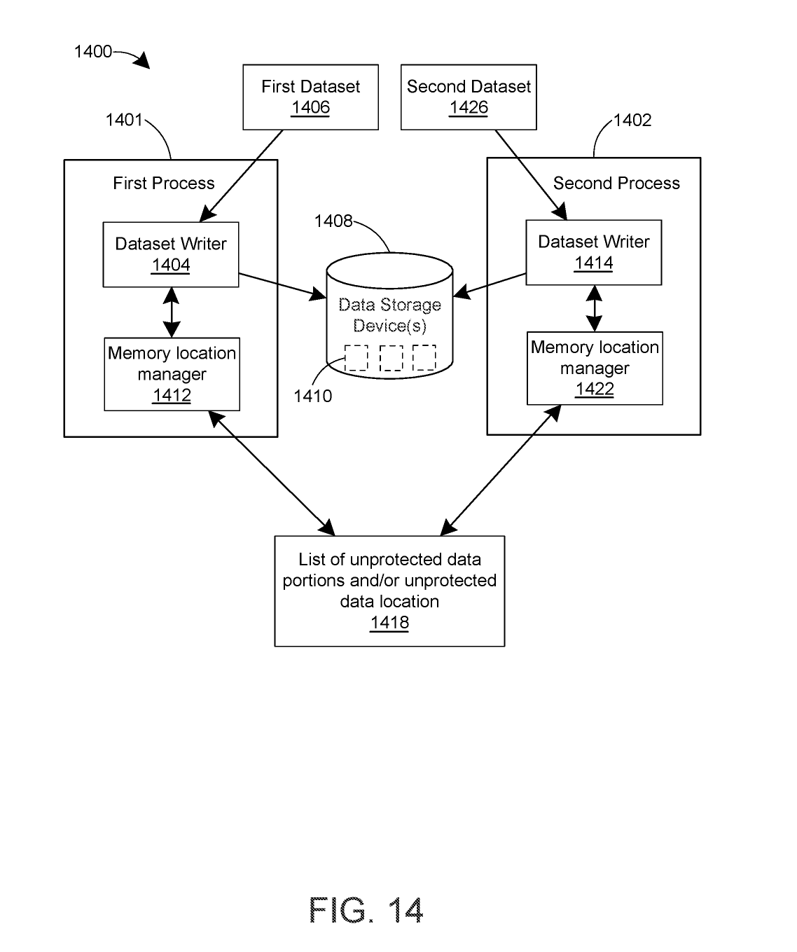

Reference is now made to FIG. 14, which is a simplified conceptual illustration of a system 1400 for managing the writing of a dataset to a data storage device, according to one or more embodiments. The system 1400 can be implemented in a computer (e.g., a desktop, a laptop, a tablet, a smartphone, a server, or other microprocessor-based device) or in multiple computers in network communication with each other. In system 1400, a first computer-implemented process 1401 for compiling, downloading, storing, and/or installing a first dataset 1406 is initiated. The first process 1401 can be, for example, a computer downloading core files for a computer software application, as described above. In another embodiment, the first process 1401 can be a server storing at least a portion (e.g., core files) or all of a computer software application (e.g., that includes core files and supplemental data files) uploaded by a developer. In another embodiment, the first process 1401 can be a server compiling at least a portion or all of a computer software application (e.g., some or all of core files and/or some or all of the supplemental data files).

Process 1401 includes a dataset writer 1404 configured to write the first dataset 1406 to one or more data storage devices 1408, such as where the various portions of first dataset 1406 are downloaded via a computer network and then written to corresponding data storage locations 1410 on data storage devices 1408. Process 1401 can also be for installing, compiling, or storing portions of first dataset 1406 on data storage locations 1410 on data storage devices 1408, as discussed above.

First dataset 1406 can be, for example, a collection of the files, such as core files and data files, that make up a computer software application, such as a game, a software tool (e.g., a word processing program, etc.), or other application. The core files can include at least one executable file that launches the computer software application, as discussed above. Preferably, all of the data storage locations 1410 that are required to accommodate the writing of first dataset 1406 to data storage devices 1408 are reserved in advance by dataset writer 1404 once the storage requirements of first dataset 1406, such as its file names and sizes, become known to dataset writer 1404, such that even before dataset writer 1404 downloads a given portion of first dataset 1406 the portion is already associated with a particular data storage location 1410 to which the portion is to be written. In other embodiments, the dataset writer 1404 reserves the data storage locations 1410 as the files are retrieved or created.

To reserve the data storage locations 1410, dataset writer 1404 communicates with memory location manager 1412. Memory location manager 1412 receives requests to write data from dataset writer 1404 and determines the memory storage locations 1410 that dataset writer 1404 can use to write data portions for the first dataset 1406. To determine which memory storage locations 1410 are available for dataset writer 1404, memory location manager 1412 checks a list 1418 that identifies the unprotected data portions and/or the corresponding unprotected data storage locations 1410 in which the unprotected data portions reside. These unprotected data portions and their corresponding unprotected data storage locations 1410 are available to dataset writer 1404 to write data portions for the first dataset 1406. To reserve certain data storage locations 1410 for the first process 1401, the memory location manager 1412 removes them (and their corresponding resident data portions) from the list 1418 of unprotected data storage locations, such that they become protected data storage locations and protected data portions. Similarly, to reserve certain data portions stored in corresponding data storage locations 1410, memory location manager 1412 can remove those data portions from the list 1418, in addition to the data storage locations that store the reserved data portions, such that the reserved data portions and corresponding memory locations become protected data portions and protected data storage locations, respectively. After the data storage locations and/or data potions are removed from the list 1418, they will not be available to a second process 1402 that is writing a second dataset 1426 to the data storage device(s) 1408. Thus, any data storage location and/or data portion not in the list 1418 of unprotected data portions and/or unprotected data storage locations is not available for a process to write data to unless it has already been assigned to the process by its memory location manager.

Dataset writer 1404 is preferably configured to check list 1418, via memory location manager 1412, before writing each portion of first dataset 1406 to a data storage location 1410 to see whether or not the data storage location and/or the resident data portion stored in the data storage location is included in list 1418. If the data storage location or the resident data portion is included in list 1418, then dataset writer 1404 writes the portion of first dataset 1406 to the data storage location. If the data storage location or the resident data portion is not included in list 1418, then dataset writer 1404 does not write the portion of first dataset 106 to the data storage location.

In some embodiments, data storage locations and/or data portions assigned to the first process 1401 are removed from the list 1418 until the entire first dataset 1406 has been written to data storage device(s) 1408, in which case they are reserved and unavailable to second process 1402. In other embodiments, individual or groups of data storage location(s) are removed the list 1418, for example while a portion of first dataset 1406 is written to a group of data storage locations. In addition or in the alternative, individual or groups of data portions are removed the list 1418, for example while a portion of first dataset 1406 is written to a group of data storage locations. After dataset writer 1404 writes that portion of first dataset 1406, the group of data storage locations and/or data portions are added back to list 1418 so that they can be accessed and used by second process 1402. As a result, dataset writer 1414 in second process 1402 can write to certain data locations that include data portions of first dataset 1406 before the first process 1401 has completed writing all portions of first dataset 1406 or after the first process 1401 has completed writing all portions of first dataset 1406.

The second data 1426 written by dataset writer 1414 in the second process 1402 can include revised or replacement data (e.g., a patch) for a portion of first dataset 1406. For example, a developer may deploy second data 1426 as a patch for a computer software application. If this occurs when the user is downloading the base files to his computer (e.g., first process 1401), the computer may initiate a new process (e.g., second process 1402) to download and install the patch (e.g., second data 1426) before the base files are fully downloaded (e.g., before the first process 1401 has completed writing all portions of first dataset 1406) or after the base files are fully downloaded (e.g., after the first process 1401 has completed writing all portions of first dataset 1406). The developer can also deploy second data 1426 as a patch when the server is compiling the computer software application on data storage device(s) 1408 for download. Thus, in some embodiments, the compiling can correspond to the first process 1401 and the patching can correspond to the second process 1402.

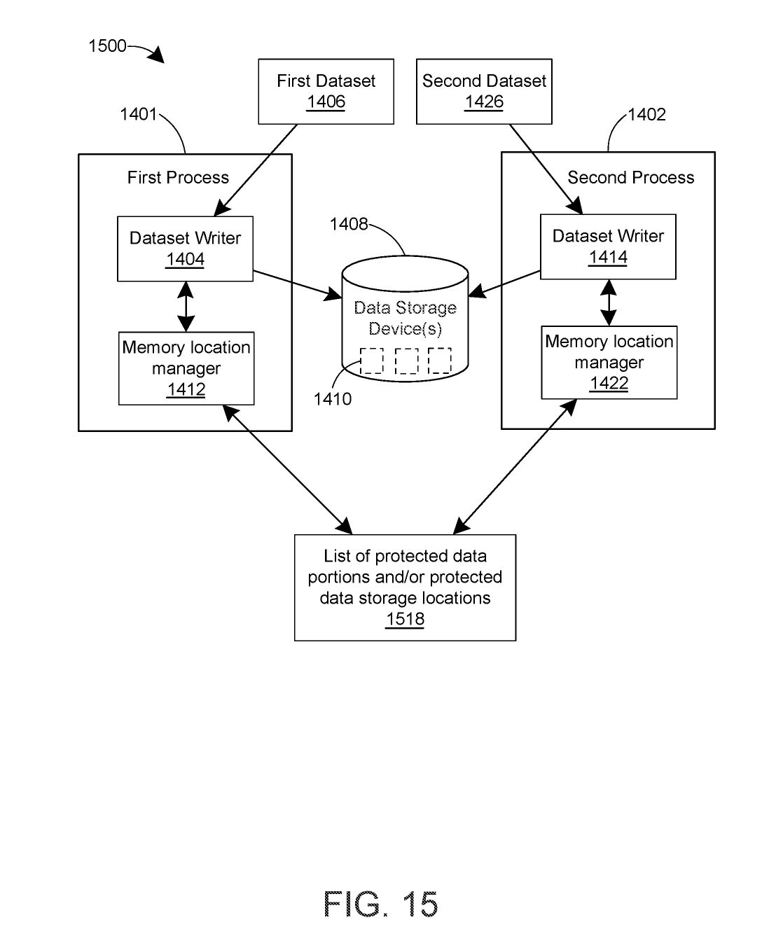

FIG. 15 is an alternative embodiment of the system 1400 illustrated and described above with respect to FIG. 14. In the system 1500 illustrated in FIG. 15, the list 1418 of unprotected data portions and/or unprotected data storage locations (from FIG. 14) is replaced with a list 1518 of protected data portions and/or protected data storage locations. The system 1500 generally operates in the same or a similar manner to system 1400, but the list 1518 is checked to determine which data storage locations and/or which data portions are unavailable to the processes 1401, 1402. Thus, instead of removing data storage locations and/or data portions from list 1418 to reserve/assign them using list 1418 (from FIG. 14), they are added to the list 1518. As in the case above, the data storage locations and/or data portions can be reserved/assigned individually or in groups (e.g., corresponding to a portion of first dataset 1406) or they can be reserved/assigned for all of first dataset 1406, in which case they are unavailable to second process 1402 until the first process 1401 has completed writing all of the portions of first dataset 1406.

In some embodiments, a data storage location and/or its resident data portion can be protected if one of the processes (e.g., first process 1401) is currently writing data (e.g., a portion of first dataset 1406) to that data storage location. In some embodiments, a data storage location and/or its resident data portion can be protected when the data stored in that data storage location is needed, now or in the future, by the computer software application. For example, the data storage location and/or its resident data portion can be protected when the resident data portion is needed by a computer software application to achieve a future state, such for a subsequent level of a video game. In some embodiments, the data or data portion(s) can include a tag or label that indicates the state(s) (e.g., level(s)) in which the data or data portion(s) is/are used in the computer software application (e.g., a game). For example, the data or data portion(s) can be tagged with levels 1 and 2 of a game, in which case the data or data portion(s) (and corresponding data storage locations) for those levels is/are protected until the user completes both level 1 and level 2. After the user completes level 2, that data or data portion(s) (and corresponding data storage locations) becomes unprotected, at which time they can be deleted or overwritten to save memory space. Thus, the tag/label can indicate that the data or data portion(s) is/are common to multiple levels of the game (or other aspects of the computer software application). In some embodiments, the data portions or elements in the second dataset 1426 can include a special flag or label to indicate that they are a patch or replacement data. The special flag/label can indicate to the second process 1402 (e.g., to memory location manager 1422) that the corresponding portions of the first dataset 1406 and their corresponding data storage locations are to be replaced even though the computer software application still needs access to them (e.g., the user has not completed level 2) and the corresponding data storage locations are protected data storage locations that are included in list 1518.

Any of the elements shown in FIGS. 14-15 are preferably implemented by one or more computers, in computer hardware and/or in computer software embodied in a non-transitory, computer-readable medium in accordance with conventional techniques.

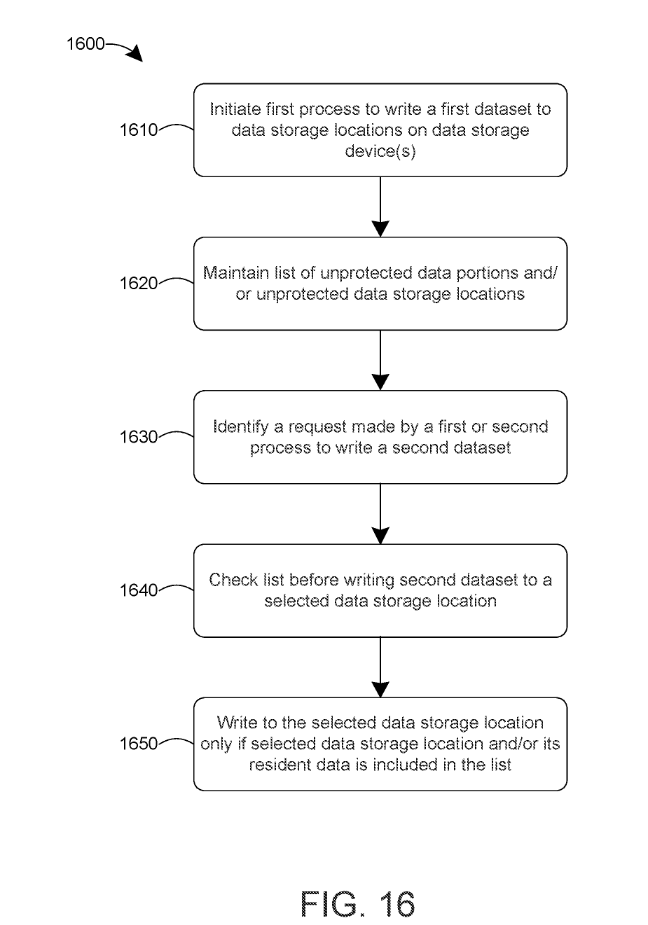

Reference is now made to FIG. 16 which is a simplified flowchart 1600 illustration of an exemplary method for managing the writing of a dataset, according to one or more embodiments of the invention. The method illustrated in FIG. 16 can be performed on one or more of the systems, devices, and/or architectures described herein. In step 1610, a first computer-implemented process is initiated. The first computer-implemented process is configured to write a first dataset (e.g., a plurality of portions of the dataset), such as first dataset 1406, to a corresponding plurality of data storage locations on at least one data storage device. The first dataset can include some or all of a computer software application, such as core files and/or supplemental data files (e.g., first and/or second supplemental data for the computer software application). In some embodiments, the computer software application initiates the first computer-implemented process, for example to request one or more supplemental data files or to request an update to one or more core files and/or supplemental data files.

In step 1620, a list of unprotected data portions and/or unprotected data storage locations is maintained by the computer system. The list of unprotected data portions and/or unprotected data storage locations includes one or more data portions and/or data storage locations that may be the subject of a write request (e.g., by the first computer-implemented process and/or by a second computer-implemented process). In step 1630, the computer system identifies a request made by the first or second computer-implemented process to write a second dataset (e.g., a patch), such as a new dataset, to one of the data storage locations and/or data portions to which the first computer-implemented process has written some or all of the portions of the first dataset. The second dataset can correspond to an update for a portion of the computer software application, such as an update to first and/or second supplemental data (e.g., as provided in first and/or second supplemental data files) for the computer software application.

In step 1640, the first or second computer-implemented process checks (e.g., using a memory location manager) the list of unprotected data portions and/or unprotected data storage locations before writing any of the portions of the second dataset to a selected data storage location to determine whether or not the selected data storage location and/or the resident data portion stored in the selected data storage location is included in the list of unprotected data portions and/or unprotected data storage locations. If the selected data storage location and/or the resident data portion is included in the list, then the selected data storage location and/or the resident data portion is available for writing by the first or second computer-implemented process.

In step 1650, the selected data storage location is written to, by the first or second process, only if the selected data storage location and/or the resident data portion is included in the list of unprotected data portions and/or unprotected data storage locations. By checking that the selected data storage location and/or the resident data portion is/are included in the list unprotected data portions and/or unprotected data storage locations, the method ensures that second dataset is not written to a protected data storage location and/or written over a protected data portion. In some embodiments, the second dataset includes a special flag or label that allows at least a portion of the second dataset to replace at least a portion of the first dataset even though a portion of the first dataset is stored in protected data storage locations and/or the portion of the first dataset is protected, for example as discussed above.

In some embodiments, the data portions stored in the unprotected data storage locations can be deleted, for example to save memory space and/or to make room for new data. For example, data or data portions for a first level of a video game can be deleted after the user passes the first level. Data or data portions for a second level of the video game can then replace or overwrite the data for the first level of the video game. In some embodiments, the data or data portions can include one or more tags that indicate where/how (e.g., in which states) the data is used in the computer software application, such as which level(s) or room(s) the data is used. When the level(s) or room(s) are no longer needed (e.g., after the user passes level 2 of a game), the data or data portions for the level(s) or room(s) can be deleted or overwritten and their corresponding data storage locations can be released by adding them to the list of unprotected data portions and/or unprotected data storage locations.

In some embodiments, the data or data portions stored in the unprotected data storage locations can be deleted when it/they is not referenced or accessed by a computer software application. For example, the computer software application may not reference or access certain data or data portions for level 1 after the user completes that level. In some embodiments, the data or data portions stored in the unprotected data storage locations can be deleted when an available storage volume of the data storage device falls below a predetermined minimum available storage volume. In some embodiments, the data or data portions stored in the unprotected data storage locations can be deleted when a total volume of data stored on the data storage device by the first computer-implemented process exceeds a predetermined maximum storage volume allocated to the first computer-implemented process. In some embodiments, a preservation or deletion priority is associated with each data element, data group, and/or data portion. The preservation priority can indicate the priority for preserving each data element/group/portion in unprotected data storage locations when the system deletes data. The deletion priority can indicate the priority for deleting each data element/group/portion in unprotected data storage locations when the system deletes data. The preservation and/or deletion priority can also be used to determine the order of deletion of each data element/group/portion from the unprotected data storage locations.

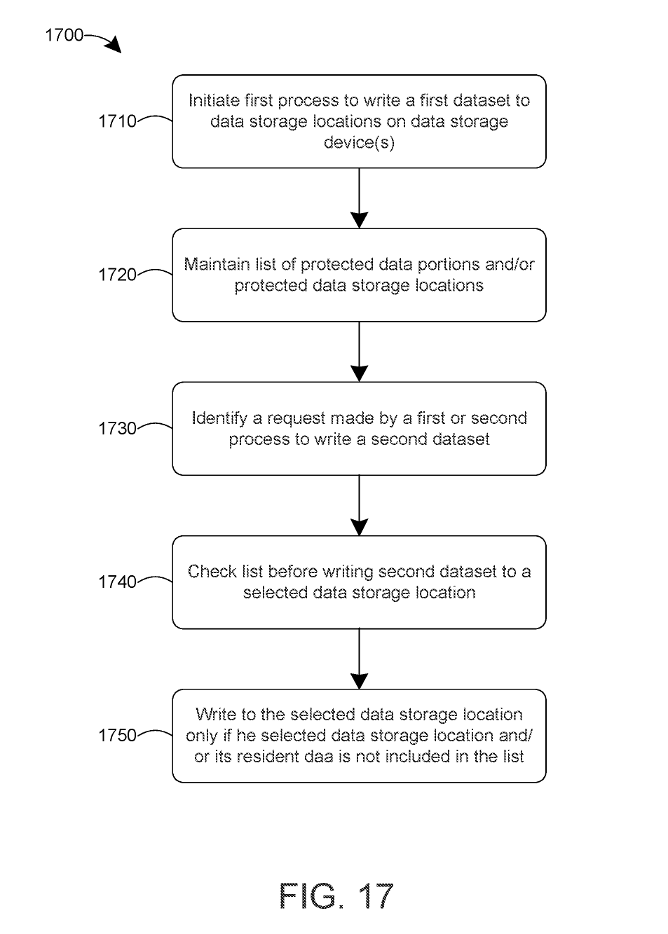

Reference is now made to FIG. 17 which is a simplified flowchart 1700 illustration of an exemplary method for managing the writing of a dataset, according to one or more embodiments of the invention. The method illustrated in FIG. 17 can be performed on one or more of the systems, devices, and/or architectures described herein. In step 1710, a first computer-implemented process is initiated. The first computer-implemented process is configured to write a first dataset (e.g., a plurality of portions of the dataset), such as first dataset 1406, to a corresponding plurality of data storage locations on at least one data storage device. The first dataset can include some or all of a computer software application, such as core files and/or supplemental data files (e.g., first and/or second supplemental data for the computer software application). In some embodiments, the computer software application initiates the first computer-implemented process, for example to request one or more supplemental data files or to request an update to one or more core files and/or supplemental data files. Step 1710 can the same or similar to step 1610, discussed above.

In step 1720, a list of protected data portions and/or protected data storage locations is maintained by the computer system. The list of protected data portions and/or protected data storage locations includes one or more data portions and/or data storage locations that may be the subject of a write request (e.g., by the first computer-implemented process and/or by a second computer-implemented process). The protected data storage locations can include data storage locations that are currently undergoing a write by the first or the second process. The protected data storage locations can also include data storage locations that have common data (e.g., as indicated by a common flag) and thus need to be retained until the common data is no longer needed (e.g., after the user completes levels 1 and 2 and the common data is for levels 1 and 2). The protected data portions can include the data portions that are currently being written by the first or the second process and/or the data portions include common data, as discussed above.

In step 1730, the computer system identifies a request made by the first or second computer-implemented process to write a second dataset (e.g., a patch), such as a new dataset, to one of the data storage locations and/or data portions to which the first computer-implemented process has written some or all of the portions of the first dataset. The second dataset can correspond to an update for a portion of the computer software application, such as an update to first and/or second supplemental data (e.g., as provided in first and/or second supplemental data files) for the computer software application.

In step 1740, the first or second computer-implemented process checks (e.g., using a memory location manager) the list of protected data portions and/or protected data storage locations before writing any of the portions of the second dataset to a selected data storage location to determine whether or not the selected data storage location and/or the resident data portion stored in the selected data storage location is included in the list of protected data portions and/or protected data storage locations. In step 1750, the selected data storage location is written to, by the first or second process, only if the selected data storage location and/or the resident data portion stored in the selected data storage location is not included in the list of protected data portions and/or protected data storage locations. By checking that the selected data storage location and/or the resident data portion is included in the list of protected data portions and/or protected data storage locations, the method ensures that second dataset is not written to a protected data storage location and/or written over a protected data portion. In some embodiments, the second dataset includes a special flag or label that allows at least a portion of the second dataset to replace at least a portion of the first dataset even though a portion of the first dataset is stored in protected data storage locations and/or the portion of the first dataset is protected, for example as discussed above.

In some embodiments, the data portions stored in the unprotected data storage locations (i.e., not stored in protected data storage locations) can be deleted, for example to save memory space and/or to make room for new data. For example, data or data portions for a first level of a video game can be deleted after the user passes the first level. Data or data portions for a second level of the video game can then replace or overwrite the data for the first level of the video game. In some embodiments, the data or data portions can include one or more tags that indicate where/how (e.g., in which states) the data is used in the computer software application, such as which level(s) or room(s) the data is used. When the level(s) or room(s) are no longer needed (e.g., after the user passes level 2 of a game), the data or data portions for the level(s) or room(s) can be deleted or overwritten and their corresponding data storage locations can be released by removing them from the list of protected data portions and/or protected data storage locations.

In some embodiments, the data or data portions that are not stored in the protected data storage locations can be deleted when they are not referenced or accessed by the computer software application. For example, the computer software application may not reference or access certain data or data portions for level 1 after the user completes that level. In some embodiments, the data or data portions that are not stored in the protected data storage locations can be deleted when an available storage volume of the data storage device falls below a predetermined minimum available storage volume. In some embodiments, the data or data portions that are not stored in the protected data storage locations can be deleted when a total volume of data stored on the data storage device by the first computer-implemented process exceeds a predetermined maximum storage volume allocated to the first computer-implemented process. In some embodiments, a preservation or deletion priority is associated with each data element, or data group, and/or data portion. The preservation priority can indicate the priority for preserving each data element/group/portion in unprotected data storage locations when the system deletes data. The deletion priority can indicate the priority for deleting each data element/group/portion in unprotected data storage locations when the system deletes data. The preservation and/or deletion priority can also be used to determine the order of deletion of each data element/group/portion from the unprotected data storage locations.

The flowchart and block diagrams in the figures illustrate the architecture, functionality, and operation of possible implementations of systems, methods and computer program products according to various embodiments of the invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. It is noted that one or more blocks from a first flowchart can be combined with one or more blocks from a second flowchart, and that the flowcharts are solely provided to illustrate exemplary embodiments.

It will be appreciated that any of the elements described hereinabove may be implemented as a computer program product embodied in a computer-readable medium, such as in the form of computer program instructions stored on magnetic or optical storage media or embedded within computer hardware, and may be executed by or otherwise accessible to a computer (not shown).

While the methods and apparatus herein may or may not have been described with reference to specific computer hardware or software, it is appreciated that the methods and apparatus described herein may be readily implemented in computer hardware or software using conventional techniques.

While the invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A computer-implemented method for managing the writing of datasets, the method comprising:
initiating a first computer-implemented process to write a plurality of portions of a first dataset to a corresponding plurality of data storage locations on at least one data storage device;
maintaining a list of unprotected data portions that may be the subject of a write request by the first or a second computer-implemented process for new data;
identifying a request made by the first or second computer-implemented process to write a second dataset to one of the data storage locations that the first computer-implemented process has written some or all of the portions of the first dataset to;
checking the list of unprotected data portions before writing any of the portions of the second dataset to a selected data storage location among any of the data storage locations to determine whether or not the selected data storage location is available for writing to based on whether a resident data portion stored in the selected data storage location is included in the list of unprotected data portions; and
writing to the selected data storage location only if the resident data portion is included in the list of unprotected data portions.

2. The computer-implemented method of claim 1, wherein the portions of the first dataset include first supplemental data for a computer software application running on a client device.

3. The computer-implemented method of claim 2, wherein the second dataset corresponds to at least one update to the first supplemental data for the computer software application.

4. The computer-implemented method of claim 2, wherein the computer software application initiates the first computer-implemented process.

5. The computer-implemented method of claim 2, wherein the second dataset includes second supplemental data for the computer software application.

6. The computer-implemented method of claim 5, wherein the second supplemental data include a pointer to a portion of the first supplemental data written to a protected data storage location.

7. The computer-implemented method of claim 5, further comprising determining that a portion of the first supplemental data is a common data portion to the second supplemental data.

8. The computer-implemented method of claim 7, further comprising removing the common data portion from the list of unprotected data portions.

9. The computer-implemented method of claim 1, further comprising deleting data portions that are included in the list of unprotected data portions.

10. The computer-implemented method of claim 9, wherein the deleting occurs when the data portions are not referenced or accessed by a computer software application, the computer software application and the first computer-implemented process running on a client device.

11. The computer-implemented method of claim 10, further comprising receiving, from the computer software application, a release notification that indicates that a portion of the first supplemental data is no longer needed by the computer software application.

12. The computer-implemented method of claim 9, wherein the deleting occurs when an available storage volume of the data storage device falls below a predetermined minimum available storage volume.

13. The computer-implemented method of claim 9, wherein the deleting occurs when a total volume of data stored on the data storage device by the first computer-implemented process exceeds a predetermined maximum storage volume allocated to the first computer-implemented process.

14. The computer-implemented method of claim 9, further comprising:
determining a deletion priority of the data portions that are included in the list of unprotected data portions; and
determining an order of deletion of the data portions that are included in the list of unprotected data portions based, at least in part, on the deletion priority.

15. A computer-implemented method for managing the writing of datasets, the method comprising:
initiating a first computer-implemented process to write a plurality of portions of a first dataset to a corresponding plurality of data storage locations on at least one data storage device;
maintaining a list of protected data storage portions that may be the subject of a write request by the first or second computer-implemented process for new data;
identifying a request made by the first or a second computer-implemented process to write a second dataset to one of the data storage locations that the first computer-implemented process has written some or all of the portions of the first dataset to;
checking the list of protected data portions before writing any of the portions of the second dataset to a selected data storage location among any of the data storage locations to determine whether or not the selected location is available for writing to based on whether or not a resident data portion stored in the selected data storage location is included in the list of protected data portions; and
writing to the selected data storage location only if the resident data portion is not included in the list of protected data portions.

16. The computer-implemented method of claim 15, further comprising deleting data portions that are not included in the list of protected data portions.

17. The computer-implemented method of claim 16, wherein the deleting occurs when the data portions are not referenced or accessed by a computer software application, the computer software application and the first computer-implemented process running on a client device.

18. The computer-implemented method of claim 17, further comprising receiving, from the computer software application, a release notification that indicates that a portion of the first supplemental data is no longer needed by the computer software application.

19. The computer-implemented method of claim 16, wherein the deleting occurs when (a) an available storage volume of the data storage device falls below a predetermined minimum available storage volume or (b) a total volume of data stored on the data storage device by the first computer-implemented process exceeds a predetermined maximum storage volume allocated to the first computer-implemented process.

20. The computer-implemented method of claim 16, further comprising:
determining a deletion priority of the data portions that are not included in the list of protected data portions; and
determining an order of deletion of the data portions that are not included in the list of protected data portions based, at least in part, on the deletion priority.
